(19) United States
(12) Patent Application Publication
(10) Pub. No.: US 2013/0179243 A1
(43) Pub. Date: Jul. 11, 2013

(54) Tools For Communicating, And Tools For Configuring And Managing Communicated Data

(71) Applicant: Barbara J. Wescott, Tallahassee, FL (US)

(72) Inventor: Barbara J. Wescott, Tallahassee, FL (US)

(21) Appl. No.: 13/348,149

(22) Filed: Jan. 11, 2012

(51) Int. Cl. G06Q 30/02

(52) U.S. Cl. 705/14.23

(57) ABSTRACT

Apparatus are provided that include a provider interface configured to communicate with at least one provider access device, and a consumer interface configured to communicate with at least one consumer access device. A rewards program engine is configured to communicate with the provider interface to allow a provider to create and manage a rewards program for offering rewards points to consumers as part of a transaction. The rewards program engine presents a template to the provider for creating the rewards program, and the rewards points are available for use in subsequent transactions with the provider. A consumer rewards engine is configured to communicate with the consumer interface to allow a consumer to manage rewards points from one or more providers.

### FIELD OF THE DISCLOSURE

Aspects of the present disclosure relate to tools for communicating among various parties. Other aspects relate to tools for prompting human user input, accepting human user input, portraying (e.g., displaying), organizing, managing, transmitting, and receiving certain data, e.g., setup data, sales transaction data, and rewards program data. Still other aspects relate to tools for coordinating data collection and communications among different parties, e.g., in order to create and manage rewards programs and incentive and rewards data associated with those programs.

### BACKGROUND

Communication and data management systems can be used in various ways by service or product providers (providers), for example, as a way to attract and retain consumers. This can include a provider's use of rewards programs to gain loyalty from consumers. Many providers have various types of rewards programs that offer points or other incentives to a consumer when the consumer purchases a good or service from the provider. The points of incentives can be offered or tendered by the consumer in future transactions, thus enticing the consumer back to the provider. On the consumer side, the use of rewards programs can become cumbersome to a consumer as they must separately manage and track their rewards from different providers. On the provider side, it can be difficult and costly to implement a rewards program, and then manage and track rewards and other data associated with participating consumers.

### SUMMARY

In accordance with one aspect of the present disclosure, apparatus are provided that include a provider interface configured to communicate with at least one provider access device, and a consumer interface configured to communicate with at least one consumer access device. A rewards program engine is configured to communicate with the provider interface to allow a provider to create and manage a rewards program for offering rewards points to consumers as part of a transaction. The rewards program engine presents a template to the provider for creating the rewards program, and the rewards points are available for use in subsequent transactions with the provider. A consumer rewards engine is configured to communicate with the consumer interface to allow a consumer to manage rewards points from one or more providers.

### BRIEF DESCRIPTION OF THE DRAWINGS

Embodiments of the disclosure are further described in the detailed description which follows, by reference to the noted drawings, in which like reference numerals represents similar parts throughout the several views of the drawings, and wherein:

FIG. 1 is a block diagram of a communications system;

FIG. 2 is a schematic diagram of various data types of the communications system of FIG. 1;

FIG. 3 is a schematic diagram of selects elements of a provider or consumer access device;

FIGS. 4A-4F depict a flowchart illustrating acts of setting up and managing a rewards program by a provider;

FIG. 5 is a schematic diagram of an embodiment of a user interface of a template for creating a rewards program;

FIG. 6A is a schematic diagram of another embodiment of a user interface of a template for creating a rewards program;

FIG. 6B is a schematic diagram of another embodiment of a user interface of a template for creating a rewards program;

FIG. 7 is a schematic diagram of an embodiment of a user interface of a main screen presented to a provider after the provider has logged in to a communications system;

FIG. 8 is a schematic diagram of an embodiment of a user interface of a consumer information tool presented to a provider;

FIG. 9 is a schematic diagram of an embodiment of a user interface of a group purchase tool presented to a provider;

FIGS. 10A-10D depict a flowchart illustrating acts of setting up, redeeming, and/or managing one or more rewards programs by a consumer;

FIG. 11 is a schematic diagram of an embodiment of a consumer information interface;

FIG. 12 is a schematic diagram of another embodiment of a consumer information interface;

FIG. 13 is a schematic diagram of consumer rewards points redemption interface;

FIG. 14 is a schematic diagram of a consumer marketplace interface; and

FIG. 15 depicts a flowchart illustrating the interaction between a communication system, one or more providers, and one or more consumers.

### DETAILED DESCRIPTION

In accordance with one or more embodiments herein, various terms may be defined as follows.

A consumer, per one or more select embodiments herein, may be any individual or entity that purchases or consumes products or services from a provider, and receives, manages, and/or redeems rewards (e.g., rewards points) related to such purchases or consumption.

A provider, per one or more select embodiments herein, may be any individual or entity, including corporations and other businesses, that provides products or services to consumers, and collects, creates, and/or manages rewards data and other data associated with the consumers, e.g., as part of a rewards program.

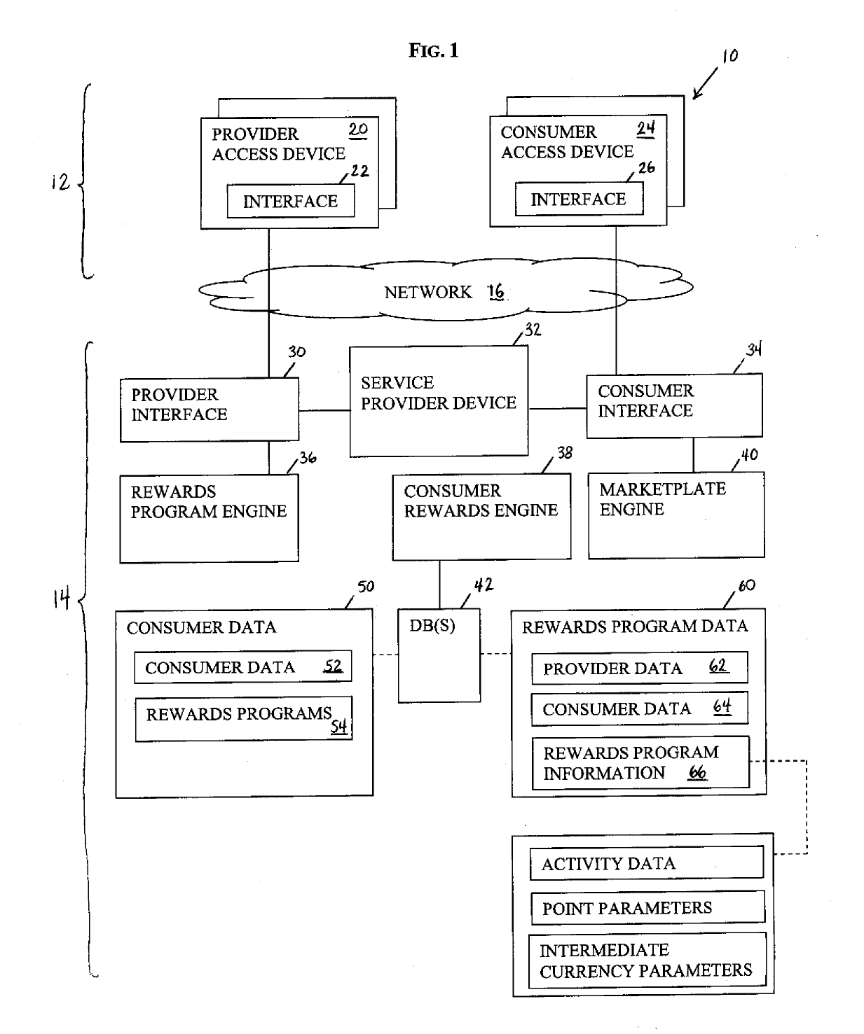

Referring now to the drawings in greater detail, FIG. 1 is a block diagram of a communications system 10 per one embodiment of the present disclosure. The communications system 10 includes one or more front-end components 12, one or more back-end components 14, and a communications portal or network 16 that exchanges information between the front-end components 12 and back-end components 14.

The front-end components 12 include one or more provider access points located on one or more provider access devices 20, and one or more consumer access points located on one or more consumer access devices 24. The provider access devices 20 can include an interface 22, such as a network interface or other type of interface, to allow the front-end components 12 to communicate with other components and/or devices, including the back-end components 14, through the network 16. Similarly, the consumer access devices 24 can include an interface 26, such as a network interface or other type of interface, to allow the front-end components 12 to communicate with other components and/or devices, including the back-end components 14, through the network 16.

In one embodiment, the back-end components 14 include one or more provider interfaces 30, one or more consumer interfaces 34, a service provider device 32, a rewards program engine 36, a consumer rewards engine 38, a marketplace engine 40, and one or more databases 42. The various engines can be in the form of configuration tools to allow the communications system 10 to aggregate and configure sets of assets or data.

The provider access devices 20 are configured to connect, via the interface 22, to the one or more provider interfaces 30 via the network 16, that can be, for example, a wide area network (WAN). The consumer access devices 24 are configured to connect, via the interface 26, to the one or more consumer interfaces 32 via the network 16, that can be, for example, a WAN. The provider access devices 20 and the consumer access devices 24 can be various types of devices, for example, an embedded device, which may be portable and which may include a wireless device. For example, the devices 20, 24 may be in the form of a mobile telephone, smartphone, personal digital assistant, handheld email device, or a wireless tablet device.

The various engines 36, 38, 40 are provided to assist in the exchange of information between the providers and the consumers via their respective access devices 20, 22. In one embodiment, one or more rewards program engines 30 are provided that are configured to manage the setup and/or management of a rewards program offered by a provider. In the process of setting up and/or managing a rewards program, the one or more rewards program engines 30 produce and/or modifies data regarding the rewards program, and that data is stored in one or more databases 42 located in the back-end of the communications system 10.

Various engines are provided to set up and manage the consumer interaction with the communications system 10. One or more consumer rewards engines 38 are provided that are configured to manage the setup and/or management of consumer interaction with a rewards program offered by one or more providers, including the receipt and redemption of rewards points from one or more rewards program. In the process of setting up and/or managing consumer interaction with one or more rewards programs, the one or more consumer rewards engines produce and/or modifies data regarding the consumer and the consumer interaction with the rewards programs, and that data is stored in one or more databases 42 located in the back-end of the communications system 10. One or more marketplace engines 40 are provided that is configured to manage the setup, management, and transactions associated with rewards points from one or more rewards programs between a plurality of consumers. In the process of setting up and/or managing consumer interactions and transactions, the one or more marketplace engines 40 produce and/or modifies data regarding the consumer interactions and transactions, and that data is stored in one or more databases 42 located in the back-end of the communications system 10. It will be appreciated, however, that one engine can be provided that can handle both the setup and/or management of consumer interaction with a rewards program and the setup, management, and transactions associated with rewards points from one or more rewards programs between a plurality of consumers. For example, the consumer engine 38 can be configured to handle the functionality of both the consumer engine 38 and the marketplace engine 40.

Any given engine or tool referred to herein or any functionality referred to herein may be implemented with one or more processing circuits. For example, a processing circuit, or process mechanism may include both (at least a portion of) computer-readable media carrying functional encoded data and components of an active computer. The active computer is ready to execute (or is already executing) the functional encoded data, and thereby causes certain acts to occur. A processing circuit may also include: a machine or part of a machine that is specially configured to carry out a process, e.g., any process or functionality described herein; or a special purpose computer or a part of a special purpose computer. A processing circuit may also be in the form of a general purpose computer running a compiled, interpretable, or compilable program (or part of such a program) that is combined with hardware carrying out a process or a set of processes. A processing circuit may further be implemented in the form of an application specific integrated circuit (ASIC), part of an ASIC, or a group of ASICs. A processing circuit may further include an electronic circuit or part of an electronic circuit. Neither a processing circuit nor a process mechanism exists in the form of code per se, software per se, instructions per se, mental thoughts alone, or processes that are carried out manually by a person without any involvement of a machine.

The service provider device 34 is configured to communicate with the other back-end components 14 and the provider access device 20 and the consumer access device 24 to manage the communications system 10.

The back-end components 14 employ the one or more databases 42 to store and track information regarding the providers, the consumers, and the associated rewards programs. For example, provider and consumer accounts are created and tracked, and rewards program information is accumulated and stored. In the process of performing these tasks, the back-end components 14, for example, using processing circuitry (not shown) in the various engines, and can produce consumer data 50 and rewards program data 60.

The consumer data 34 includes various data and information regarding the consumer and their associated rewards programs. In one embodiment, the consumer data 34 includes consumer information 52, such as name, contact information, and various other pieces of information about the consumer themselves. The consumer data 50 also includes rewards program data 54. The rewards program data 54 is information about the various rewards programs that the consumer is enrolled in. For example, for each consumer associated with the communications system 10, the rewards program data 54 can include information about each of the rewards programs associated with that consumer, including the number of rewards points accrued by the consumer for each rewards program, and data to track each consumer's activity regarding each associated rewards program. It will be appreciated, however, that the consumer data 50 can include any information regarding each consumer associated with the communications system 10 regarding personal information about the consumer, and the rewards programs associated with each consumer.

The rewards program data 60 includes various data and information regarding the rewards programs and the providers associated with the rewards programs. In one embodiment, the rewards program data 60 includes provider data 62, such as provider name, contact information, and various other pieces of information about the provider themselves. The rewards program data 60 also includes consumer data 64. The consumer data 64 is information about the plurality of consumers that are enrolled in the rewards program. The consumer data 64 can include, but is not limited to, consumer name and contact information, the number of rewards points associated with each consumer enrolled in the rewards program, and information about past transaction with the provider and the use of rewards points in the past transactions. It will be appreciated, however, that the rewards program data 60 can include any information regarding each rewards program associated with the communications system 10 regarding information about the consumer, and the rewards programs associated with each consumer and each provider.

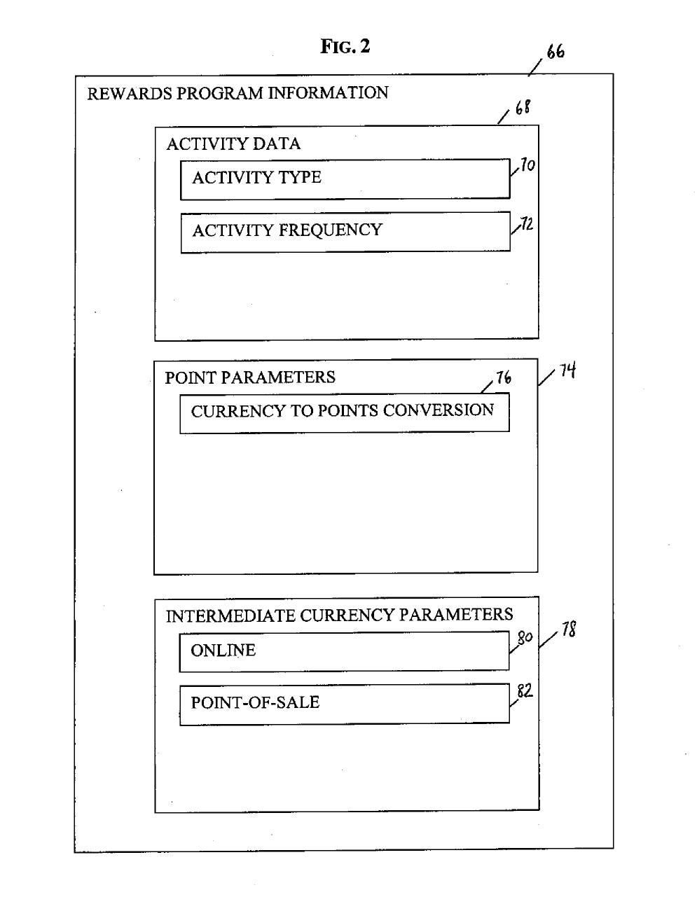

The rewards program data 60 also includes rewards program information 66, which contains information about the rewards program for each provider associated with the communications system 10, which can be seen in more detail in FIG. 2. The rewards program information 60 includes activity data 68, which is data regarding the types of activity that result in a consumer accruing one or more rewards points. For example, the types of activity that can result in the accrual of one or more rewards points can include completing a transaction with a provider, referring a new consumer to a provider that may or may not result in a transaction between the new consumer and the provider, and consumer response to announcement or advertisements presented by the provider, which can be stored as activity type data 70. The activity data 68 can also include activity frequency data 72 in the event that a certain activity type required more than one occurrence to result in the accrual of rewards points. For example, a certain provider may require multiple referral of new consumers to the provider in order to result in the accrual of one or more rewards points. The rewards program information 60 can also include point parameters 74 that can include information about the amount of rewards points received for each activity type. For example, the point parameters 74 can include currency to point conversion data 76 for converting each dollar spent during a transaction with a provider into one or more rewards point or a fraction of a rewards point. The rewards program information 66 can also include intermediate currency parameters 78 that have information about the intermediate steps between the request for redemption of rewards point by a consumer and the actual redemption of the rewards points for a transaction with the provider. For example, the intermediate currency parameters 78 can include an online transaction 80 that can provide a code or other data to be used in an online transaction with the provider, or a point-of-sale transaction 82 that can provide a printable coupon or other data to be used in a point-of-sale transaction with a provider in, for example, a retail location. It will be appreciated, however, that the rewards program information 6 can include any information regarding each rewards program and the manner in which each rewards program allows a consumer to accrue and use rewards points for transactions with the provider.

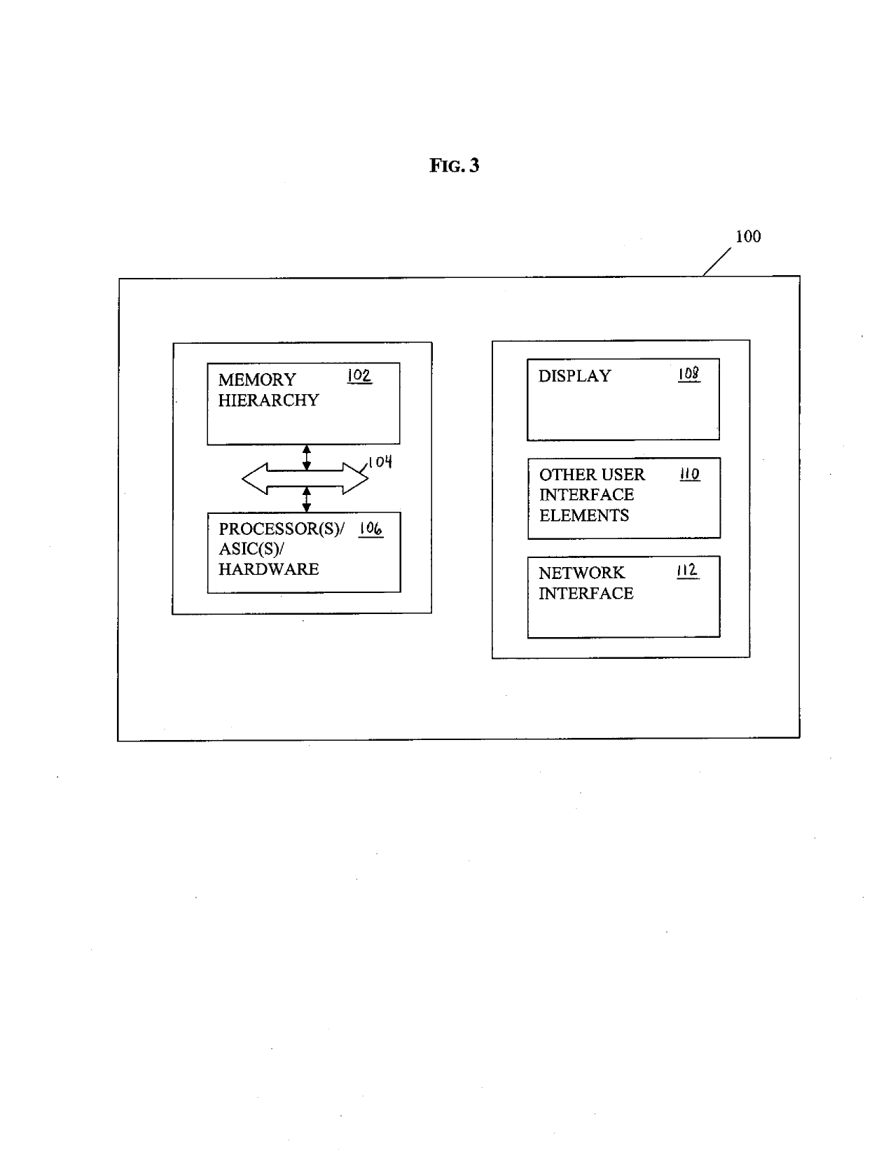

FIG. 3 is a schematic diagram of select elements of a provider or consumer access device. The illustrated device 100 may, for example, include an embedded device, which may be portable and which may include a wireless device. For example, the device 100 may be in the form of a mobile telephone, smartphone, personal digital assistant, handheld email device, or a wireless tablet device. Generally, the device 100 is one with computing, display, and/or input/output capability, and may include one or more interfaces that are configured to interface with a network, such as a wide area network (WAN).

The device 100 includes certain types of processing circuitry. In one embodiment, the processing circuitry includes hardware elements, for example, that can include but are not limited to a memory subsystem 102, a bus 104, and a processor(s)/ASIC(s)/other hardware 106. The processor(s)/ASIC(s)/other hardware 106 may include a display 108, other user interface elements 110, and network interface circuitry 112. The display 108 and its features can vary, but can, for example, include an LCD or other type of computer display or device display. The other user interface elements 110 may include, for example, a keypad, soft keys, touch screen elements, and pointing devices such as roller balls, rotatable discs, and the like. The network interface circuitry 112 may include, for example, network interface hardware and driver software encoded on machine or computer readable media and may be configured to interact with the interface hardware to cause, for example, wireless protocol communications with a wireless network. The network interface circuitry 112 can also include other types of wireless or wired network interconnection and protocol features.

As explained above, the provider access device is configured to allow a provider to access the back-end components of the communications system 10 to create and/or manage a rewards program. In one embodiment, the interface of the provider access device is configured to communicate through the network with the provider interface. This allows the provider to interact with the rewards program engine to create and/or manage a rewards program. The provider can either communicate information to the rewards program engine about an existing rewards program and manage that rewards program through the communications system 10, or the provider can create and manage a new rewards program, as will be explained in more detail below.

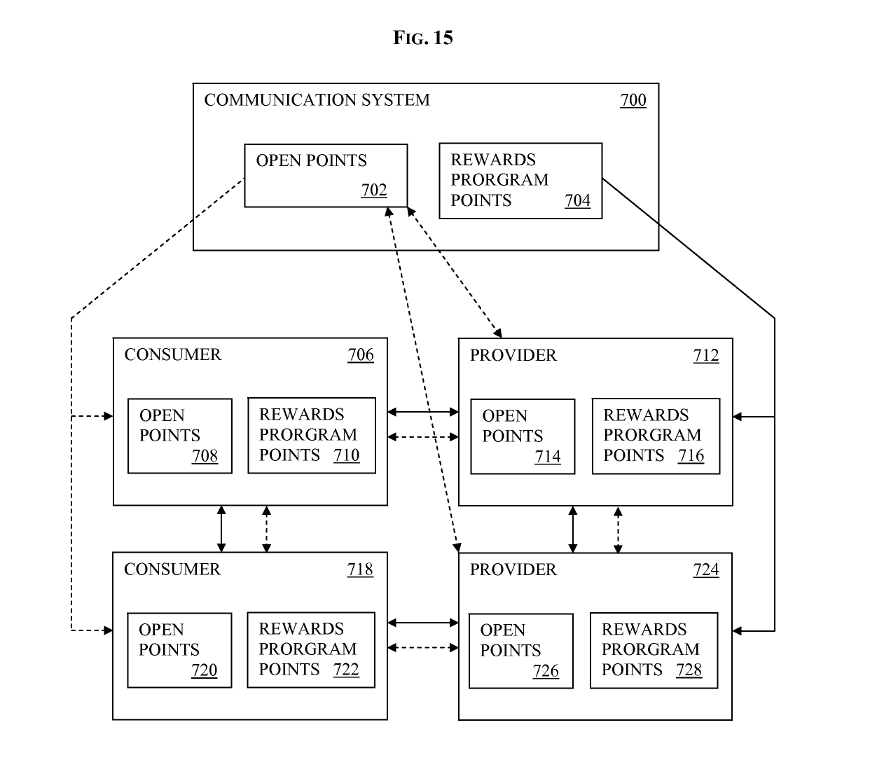

As explained above, the communication system allows one or more providers to create and manage a rewards program that allows one or more consumers to accrue rewards program points when transacting with the providers, and to use the accrued points in future transactions. FIG. 15 illustrates the various ways in which the communication system interacts with one or more providers and one or more consumers and how points flow therebetween. As shown in FIG. 15, a communication system 700 includes points in the form of rewards program points 704 that are specific to each individual provider 712, 724 and are accrued by each consumer 706, 718 when transacting with each provider 712, 724 (and are represented by the solid lines). The rewards program points are offered by the provider to a consumer upon the consumer transacting with the provider and can be used with that provider during future transactions therewith. The rewards program points 704 flow from the communication system 700 to the providers 712, 724, with each provider 712, 724 having their own unique rewards program points 716, 728. The communication system 700 also includes open points 702 that are points that can be purchased from the communication system 700 by the providers 712, 724 to be offered to consumers for use by the consumer with any other provider in the communication system (that are represented by the dashed lines), as will be discussed in more detail below. The open points 702 flow between the communication system 700 and the providers 712, 724, with each having their own open points 714, 726, and the consumers 706, 718, with each consumer having their own open points 708, 720. Each provider 712, 724 can interact with each consumer 706, 718 that is enrolled in their rewards program such that the consumers 706, 718 can accrue rewards program points 710, 722. Each consumer 706, 718 can also interact with every other consumer 706, 718 in the transaction of rewards points or open points therebetween. Similarly, each provider 712, 724 can interact with every other provider 712, 724 in the transaction of rewards points or open points therebetween.

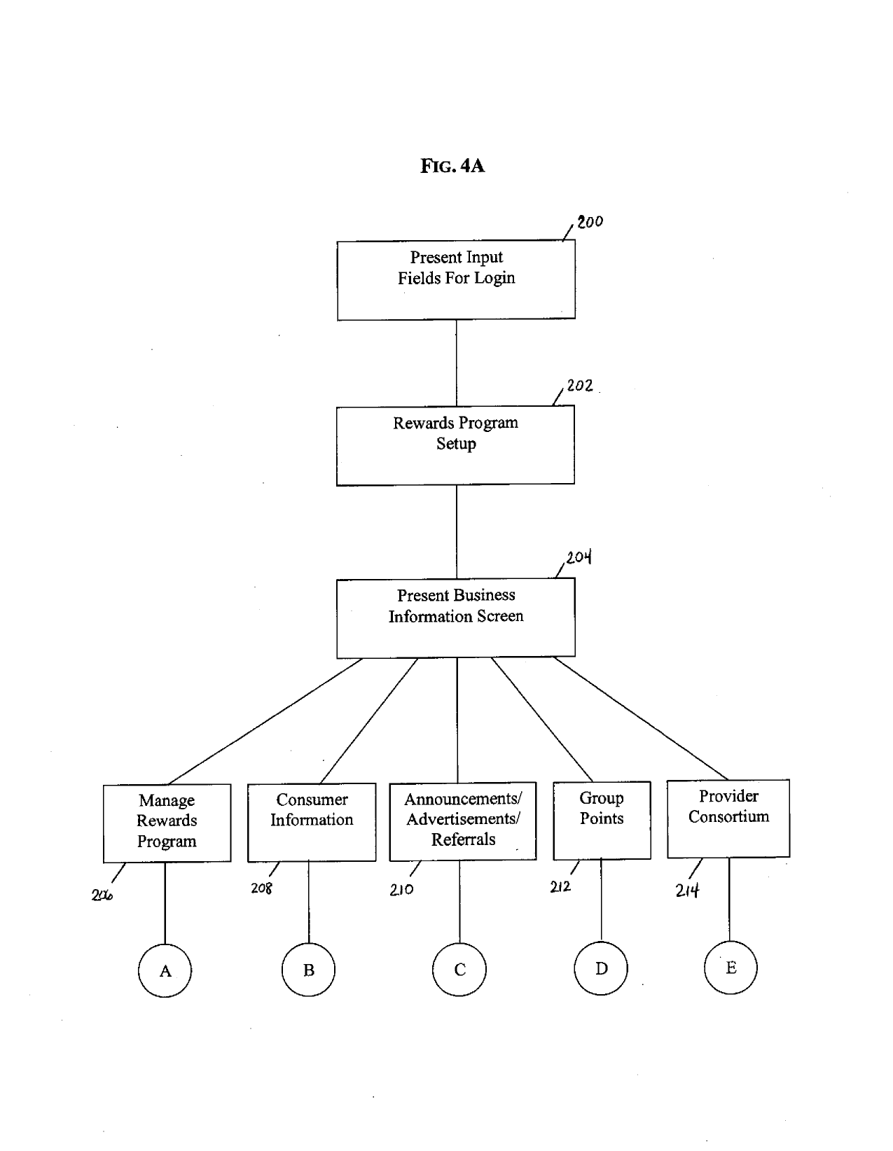

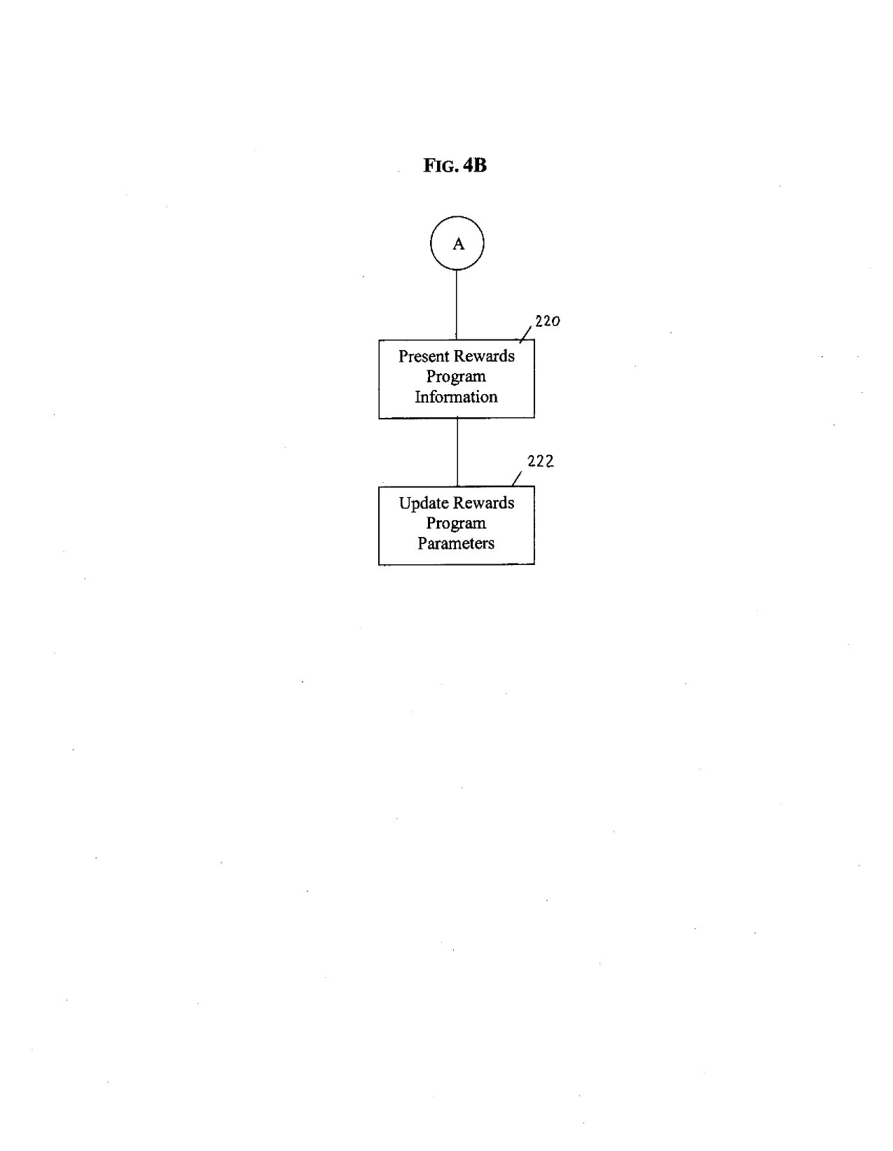

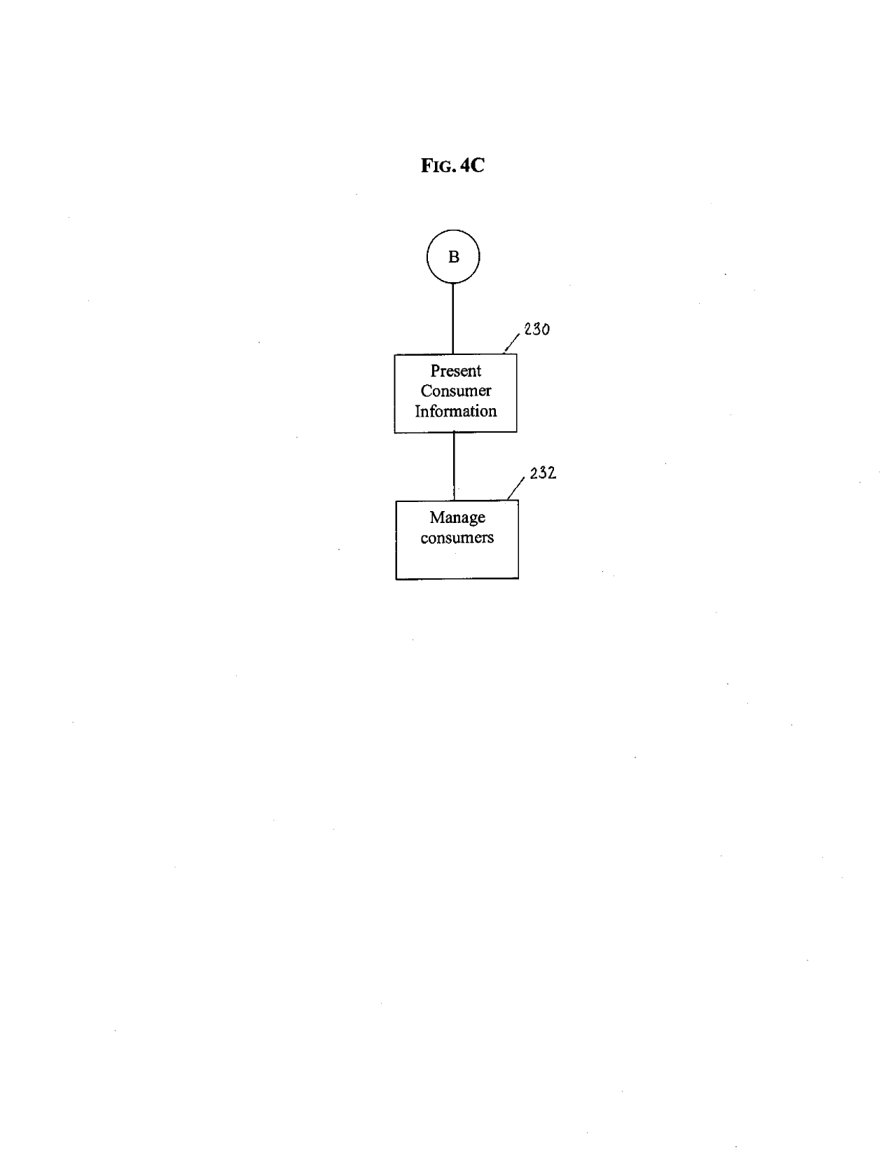

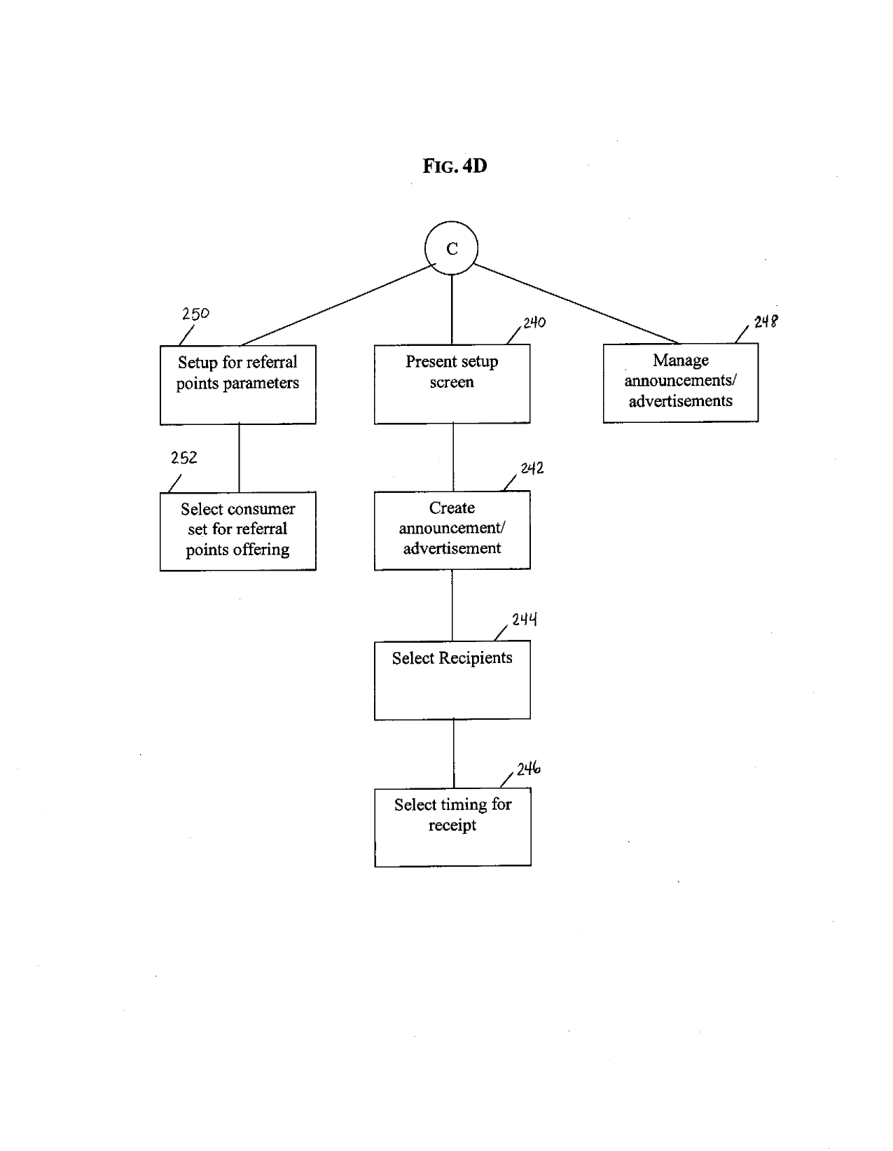

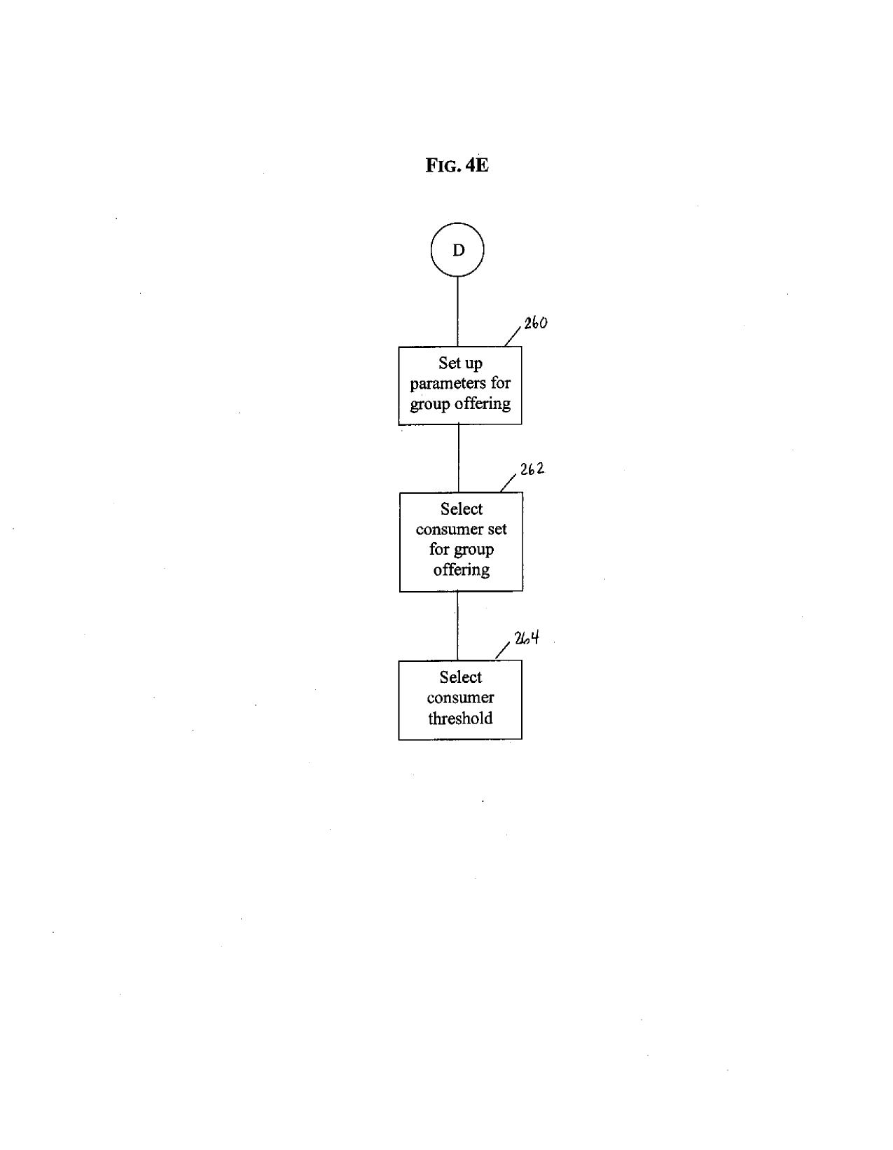

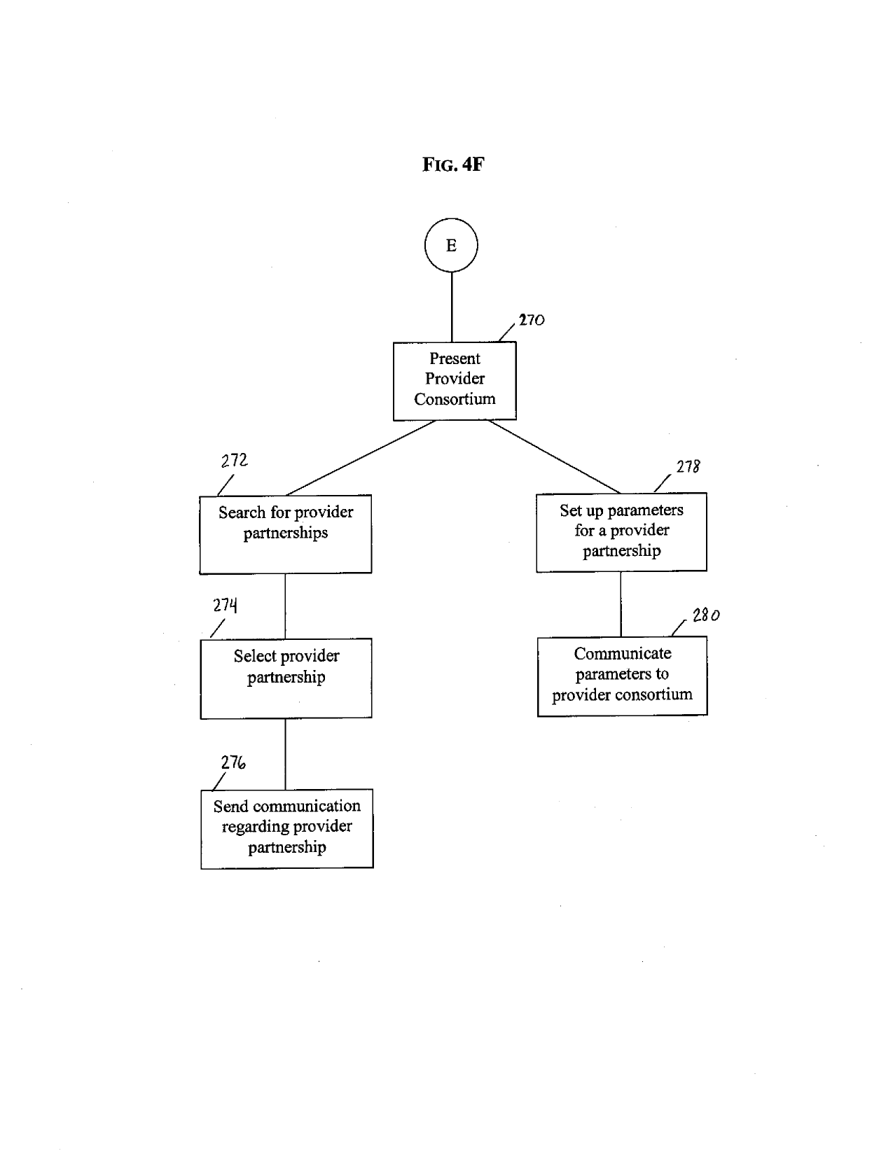

FIGS. 4A-4F shows a flowchart of processes that allow a provider to create and/or manage a rewards program. The illustrated processes are carried out, in the illustrated embodiment, by the communications system 10 shown in FIG. 1. In act 200, a main/login page is presented on the provider access device, for example, on a display on the provider access device 20, to allow the provider to enter the communications system 10. In one embodiment, the login screen may include, for example, authentication graphical tools, such as username and password graphical tools. In another embodiment, the login screen may employ non-graphical authentication tools to allow the provider to log into the system.

When graphical tools are provided, the authentication graphical tools may be graphical input/output tools that communicate to the provider the type of information to be input, and then accept that input from the provider. The username graphical tool and the password graphical tool may include an input field for text to allow the provider to enter a username and password into the login screen. For example, a provider may be provided with a unique login account including a unique username.

Additional graphical tools may be provided in addition to the username graphical tool and the password graphical tool. The additional graphical tools may be part of the same login page as the username graphical tool and the password graphical tool, or may be presented on a separate page or through the use of an access wizard. For example, a graphical tool can be employed when a provider has forgotten the password for login.

This tool can present the provider with a secret question with an answer that had been provided by the provider during the account setup (which will be discussed in more detail below). Upon submission of the answer to the secret question by the provider, an email can be generated to be sent to the contact email address for the provider. The tool can also provide a place for the provider to enter a contact email address that is associated with the account for the tool to email the password to the provider.

These additional graphical tools may be provided in an instance where the provider is required to set up an account, at act 202. Setting up a rewards program in act 202 is only required one time when a provider accesses the system for the first time, and can be skipped upon all subsequent visits. During the setup of a rewards program in act 202, a provider can either provide information about a currently existing rewards program or create a new rewards program. In either case, various tools can be employed to receive information from the provider to set up an account and the rewards program. For example, a graphical tool can be employed when a provider has to set up a new account. This tool can present the provider with various other tools for entering information about the provider. For example, a provider can provide information including provider name, contact information including mailing address, telephone number, and/or contact email address, fax number, a password, password confirmation, password secret question and answer in the event of a forgotten password, and/or other pertinent information.

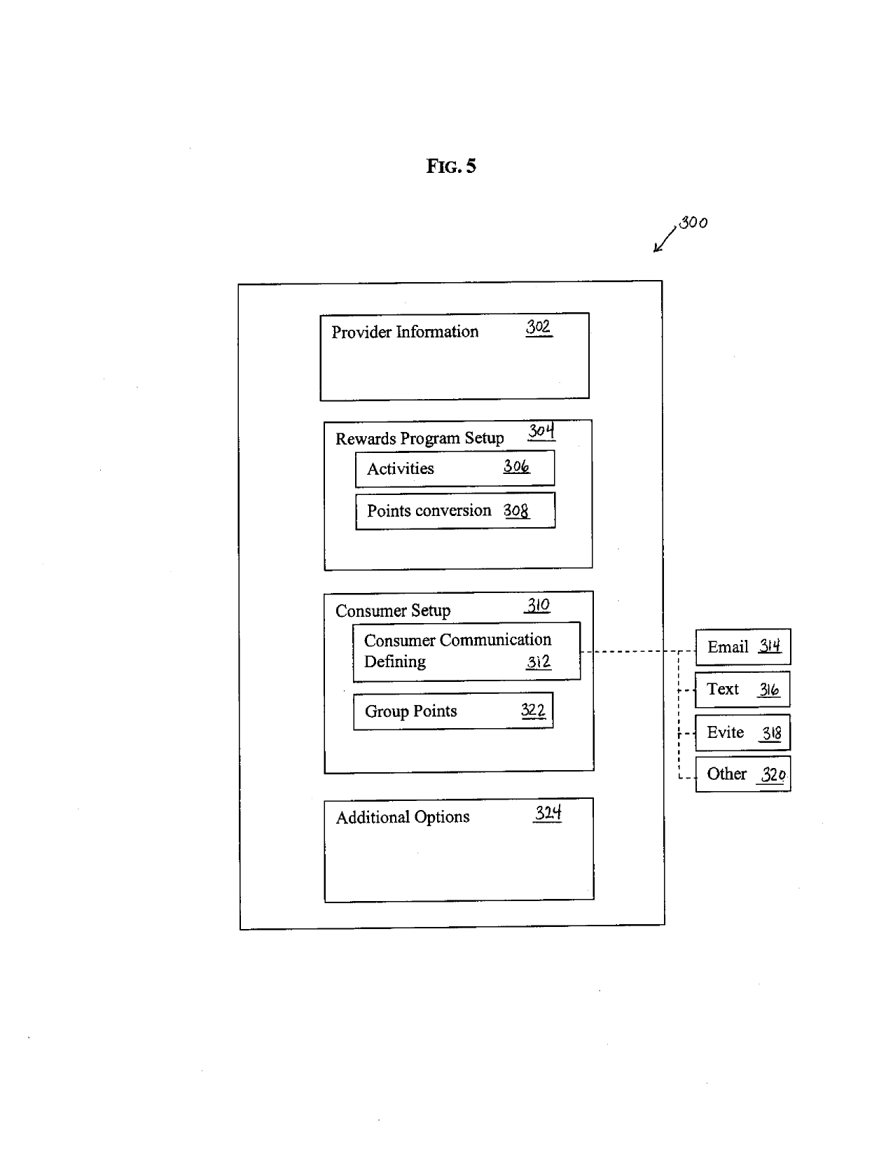

In one embodiment, a provider can setup a rewards program using one or more templates provided by the communications system 10. A graphical user interface element may be displayed to the provider on the provider access device 20 that is configured to display a template to the provider to allow the provider to create a rewards program. The options presented to the provider may be depicted with text, icons, pictures, or other graphical indicators communicating the choices to the providers. In one embodiment shown in FIG. 5, a template 300 for creating a rewards program includes a provider information tool 302 that is configured to accept information from the provider about the provider, including but not limited to name, address and other contact information, and email address. A rewards program setup tool 304 is configured to allow the provider to choose from various options to create the rewards programs, such as the type of activity that gives rewards points to a consumer, and the currency to point conversion that determines how many rewards points a consumer receives based on the activity that caused the rewards point accrual. The rewards program setup tool 304 can include an activity tool 306 that allows the provider to input or select from various activities that may cause rewards points accrual, and a points conversion tool 308 that allows the provider to enter or select from various points conversion values. A consumer setup tool 310 is configured to allow the provider to set various parameters in the management of consumers that are enrolled in the rewards program. For example, the consumer setup tool 310 can include a consumer communication defining tool 312 to allow the provider to choose to interact with consumers via select ones of email, text, evite, or other communication means. In this regard, these communication channels may be selected by interacting with an email tool 314, a text tool 316, an evite tool 318, and one or more other communication channel tools 320, each of which may include a mechanism for accessing further graphical tools for reviewing and defining configuration parameters associated with those communication channels. The consumer setup tool 310 can also include a group offering tool 322 to allow the provider the ability to offer group offering to the consumer, which will be discussed in more detail below. The additional options tool 324 allows the provider to select from various other options to further configure the reward program.

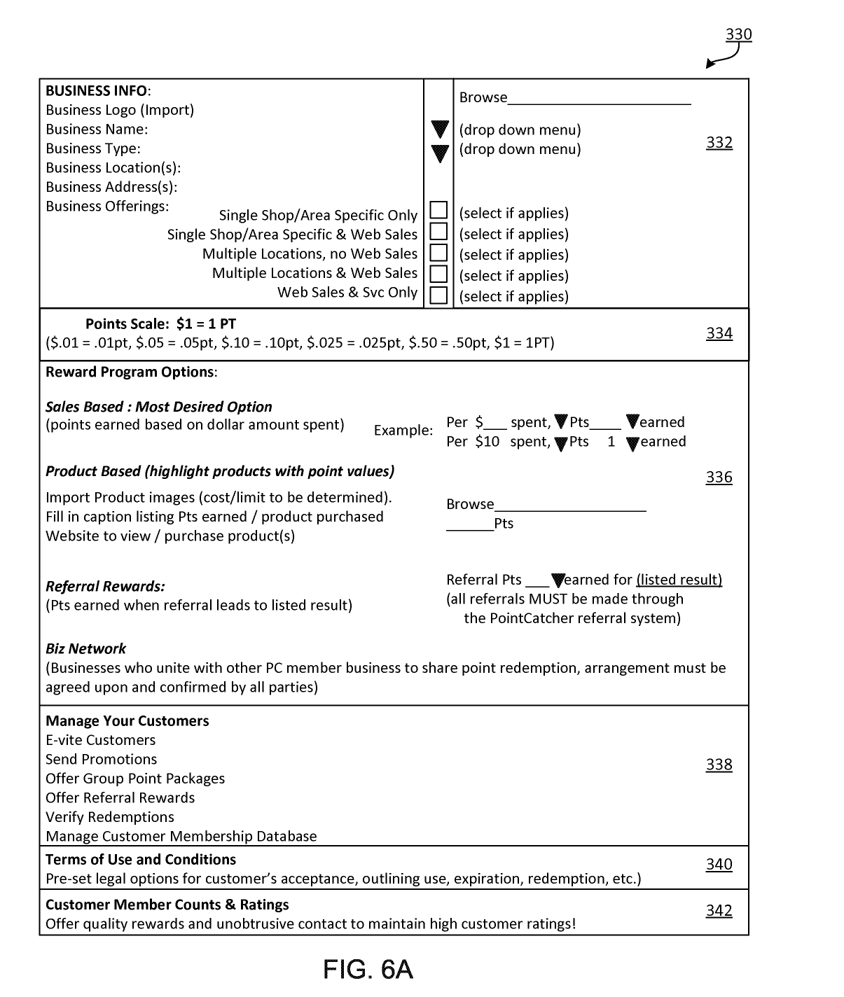

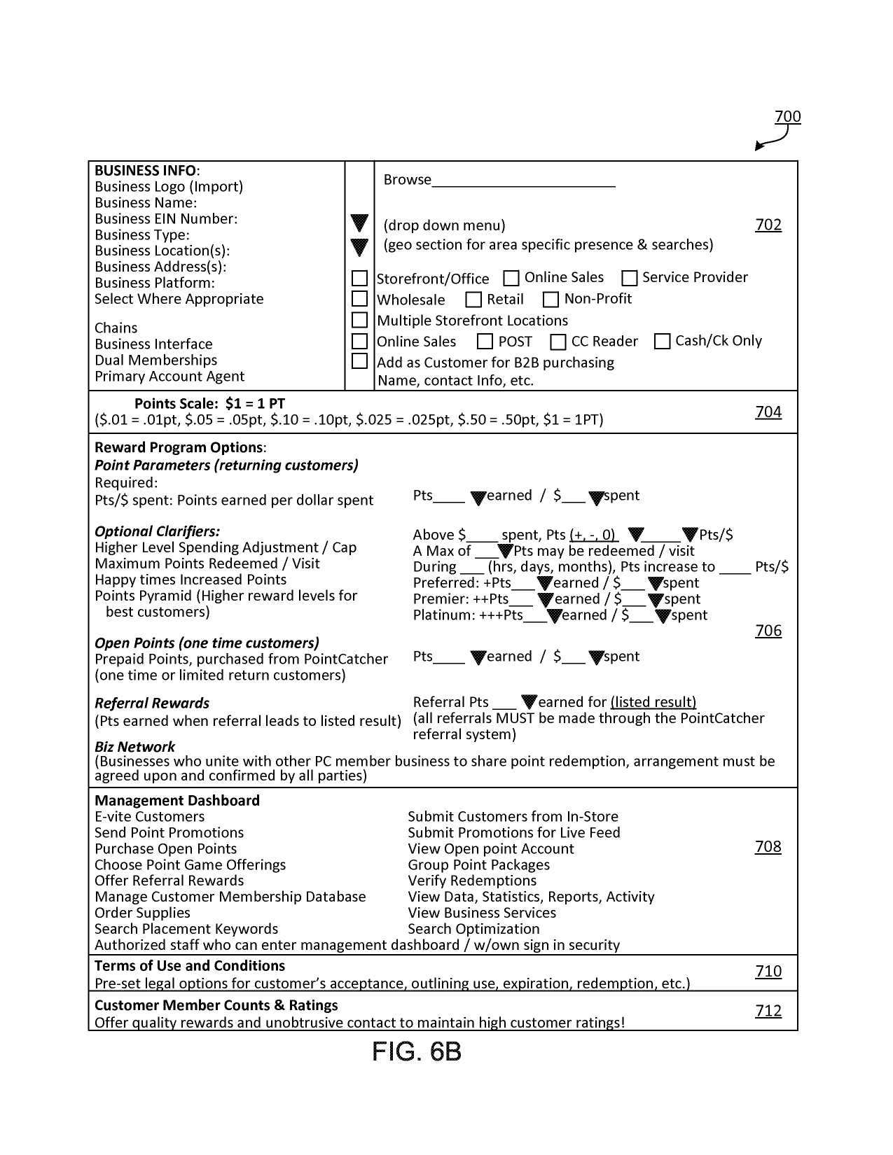

Another embodiment of a template 330 for creating a rewards program is shown in FIG. 6A. A provider information tool 332 allows a provider to enter various information about the provider, such as provider name, provider logo, provider type, location(s), address(es), and offering(s). The provider logo can be imported from various locations, including a website, or a file saved on the provider access device. Some of the fields for entering the information can include a drop-down box or other selection tool that provides various information types to be selected by the provider. In addition, in one embodiment, the provider offering(s) field can include various checkboxes or other selection mechanisms to allow the provider to indicate the type of offering provided and types of point-of-sale locations available, including single shop, multiple locations, and/or web sales. Various other types of information can be entered by the provider. For example, the provider information tool 332 can include a field to allow the provider to identify themselves as a certain type of entity, including but not limited to wholesale, retail, service provider, and/or non-profit. It will be appreciated that any type of information relating to the provider can be entered in the provider information tool 332.

The reward program created by the provider will have a point conversion that defines the number of rewards points accrued per dollar spent by a consumer with a provider. In one embodiment, the communications system 10 provides a standard point conversion that can be utilized by the providers. For example, the point conversion can mirror dollar values spent by a consumer, such that one dollar would equal one rewards program point. This provides a standard reward point conversion across the entire communication system 10. The points scale tool 334 can be configured to present the provider with the standard rewards points conversion. The provider can be allowed to alter that ratio of dollars spent to rewards points accrued such that a consumer can accrue a fraction of a dollar in rewards points for each dollar spent with the provider. In another embodiment, the communication system 10 allows the provider to customize their points scale conversion. The points scale tool 334 can be configured present the provider with the standard rewards points conversion, and/or allow the provider to select the conversion from the amount of money spent by a consumer with a provider to a reward point. It will be appreciated that the template can provide various options for the points scale conversion, or allow the provider to enter a custom points scale conversion.

The rewards program options tool 336 is configured to allow the provider to select from various additional options to customize the rewards program. For example, the provider can import images of product offerings and list the point values associated with each product, in addition to adding a caption or other information about the product, and a link to a website for the consumer to view and/or purchase the product. Another option for the provider is to allow the rewards program to include referral points. Specifically, a consumer can accrue rewards program points when they refer other entities, such as other consumers, to the provider. The provider can specify the details on how the referral rewards points can accrue, including the activity of the referred entity that must occur to cause a referral rewards point to accrue. For example, the provider can specify that the referred entity must sign up as a member of the provider's reward program, or that the referred entity must engage in a transaction with the provider in order for the consumer to receive rewards program points based on that referral. There is also an option for the provider to join a business consortium with other providers to allow the providers that join the consortium to share in various aspects of their respective rewards programs, as will be described in more detail below.

The consumer management tool 338 is configured to allow the provider to choose among options regarding the ways in which the provider can interact with consumers that are member of their rewards program and/or consumers that the provider can acquire as new members of the rewards program. The provider can choose the means to communicate various types of offers to consumers, including special promotions, advertisements, referral points offers, and other types of communications.

The legal tool 340 allows the provider to select from various terms and conditions options, and other legal options. A ratings tool 342 allows the provider to create a rating system that provides the consumers with the ability to rate various aspects of communication with a provider. For example, the consumer may be able to rate ease of use of the rewards program, customer service provided during transactions with the providers, and/or product ratings.

The communication system 10 can also offer a provider the ability to use rewards point to attract new consumer that will likely only interact with the provider a limited number of times. A provider can be offered the ability to purchase points from the communication system 10 that can be redeemed with any provider in the communication system 10. In one embodiment, an open point can be provided that can be purchased by a provider from the communication system 10. These open points can be pre-purchased from the communication system 10 and can be offered to a consumer when the consumer transacts with the provider, and the open points can be redeemed with other providers associated with the communication system 10. These open points can be utilized, for example, by a provider that will likely have one-time transactions with consumers as an incentive for transacting with the provider that can be used for future transactions with other providers associated with the communication system 10. When a consumer redeems the open points with a provider, the provider can choose to receive the value of the open points from the communication system 10, accrue the open points in their own open points account to allow the provider to give the open points to another consumer in a future transaction, use the value of the open points to offset any charges or costs associated with their participation in the communications system 10, or use the open points in their own provider-to-provider transactions with other providers in the communication system 10.

Another embodiment of a template for creating a rewards program utilizing the open points is shown in FIG. 6B. A template 700 is shown in FIG. 6B that includes a provider information tool 702, similar to the provider information tool 332 shown in FIG. 6A, to allow a provider to enter information about the provider. A points scale tool 704, similar to the points scale tool 334, allows the provider to view or customize the conversion of the amount of money spent by a consumer in a transaction with a provider to a rewards point.

The rewards program options tool 706, similar to the rewards program options tool 336, allow the provider to select from various options to customize the rewards program. In addition to various options explained above in relation to the rewards program options tool 336, the rewards program options tool 706 includes options to allow a provider to control a dollar amount at which a reward point value can increase or decrease. In one embodiment, this option is the higher level spending adjustment tool, which can allow a provider to incentivize higher spending by a consumer by having the rewards point values increase as consumer spending increases. Alternatively, a provider can limit the number of rewards points accrued during a transaction by limiting rewards point accrual after a certain dollar amount has been spent by a consumer in a transaction. The rewards program options tool 706 can also include options to vary the amount of rewards points accrued by time period. In one embodiment, a happy times points option can allow a provider to vary the amount of rewards points accrued by various time frames, including hour, day, week or month. This option can be used by a provider, for example, to offer a greater number of rewards points to a consumer who transacts with the provider during a time of day that has typically fewer transactions to incentivize consumer by offering a higher number of rewards points earned for those slower transaction time periods. The rewards program options tool 706 shown in FIG. 6B also includes an option to provide an incentive program in which customers can qualify for increased rewards points by transacting with the provider with continually higher levels of spending. In one embodiment, this points pyramid allows a provider to establish how much has to be spent per period of time for a consumer to achieve and retain a higher point earning status. For example, there can be three different levels of increased earning potential depending on the amount of money a consumer spends with a provider during a set time period. In addition to providing details about various aspects of the rewards program, using the rewards program options tool 706 can also allow the provider to view or select a rewards point conversion for open points.

The management tool 708, similar to the consumer management tool 338, allows the provider to choose among options for interacting with and/or managing the consumers and the communications system 10. For example, using the management tool 708, the provider can offer promotions to consumers, interact with the communications system 10, and evaluate reports regarding various aspects of the provider's rewards program. In addition to the various ways to communicate with and/or manage consumers, the management tool 708 allows the provider to participate in and manage open points. For example, a provider can chose to create an open points account and set various options therein. The legal tool 710 and the ratings tool 712 are similar to the legal tool 340 and ratings tool 342 shown in FIG. 6A.

In one embodiment, the service provider of the communications system 10 itself can offer open points that can be accrued by consumers and/or other providers using the communications system 10. The open points can be used by the consumers in the same way as when open points are offered by a provider, including as payment for a transaction fee for the redemption of rewards points from one of the other providers, or for the purchase of goods or services from a provider if the provider has agreed to accept the open points in lieu of or in combination with their own rewards points. The open points can be used by providers in a variety of ways as well, including the payment of fees associated with the communication system 10. The open points can also be accrued from the communication system 10 in a variety of ways, including the referral of new consumers to the communications system 10 or the referral of new providers to the communications system 10.

In one embodiment, various materials and other information can be communicated to the provider upon the creation of an account and the setting up of a rewards program with the communications system 10. For example, a provider can be provided with a packet that includes software and instructions for installation. The packet can also include various types of marketing materials to indicate to consumers the provider's enrollment with the communications system 10, and can include posters, decals, cards, or other materials. An alert can also optionally be sent out by the communications system 10 to alert all or a subset of consumers that the provider is a new provider with the system.

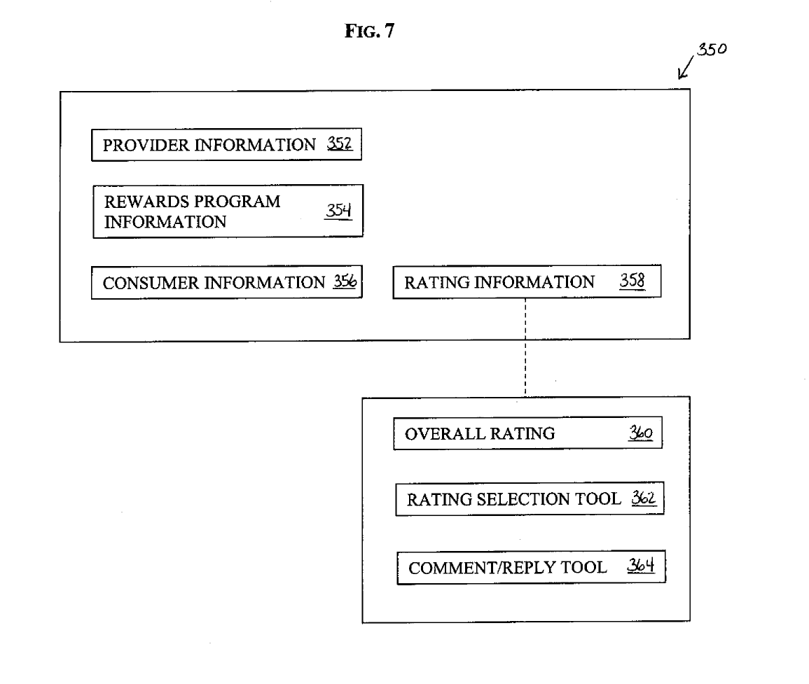

In act 204, shown in FIG. 4A, a main screen is presented to the provider on the provider access device. A graphical user interface element may be displayed to the provider on the provider access device 20 that is configured to display a main screen interface 350, shown in FIG. 7, to the provider to allow the provider to access various features of the system and the rewards program. In one embodiment, the main screen interface 350 can include a business information tool 352 that can display to the provider basic information provided by the provider about the provider, including but not limited to address and contact information. The business information tool 352 can also be configured to allow the provider to update the information, for example, a change of address or other new contact information for the provider. The rewards program information tool 354 can display to the provider various information about the rewards program. For example, the rewards program information tool 354 can display the rewards points conversion or number of consumer members of the rewards program. The rewards program information tool 354 can also be configured to allow the provider to update rewards program information and manage the rewards program. The main screen interface 350 can also include a consumer information and management tool 356 that allow the provider to access information about the consumer that are enrolled in the rewards program and manage those consumers. The main screen interface 350 can also optionally include a ratings information tool 358 that displays to the provider information about consumer rating of the rewards program or other rating information from consumers about various aspects of interactions with the provider. The ratings information tool 350 can be configured to allow the provider to view an overall rating 360 of the rewards program, and can provide a rating selection tool 362 to allow the provider to select the different types of ratings that are displayed thereto in the rating information tool 358. The rating information tool 358 can also provide a response tool 364 that allows the provider to communicate with various consumers regarding the rating information received therefrom. For example, the response tool 364 can allow the provider to address issues that are presented by a consumer, especially those with less favorable ratings to address problems that a consumer has had with the rewards program or the provider.

In act 206, the provider is presented with an interface to manage the rewards program. In one embodiment shown in FIG. 4B, an interface can be presented to the provider that displays information about the current setting of the rewards program, as in act 220, including the points conversion and the types of activity that result in the accrual of rewards points for a consumer. The interface can include tools, such as graphical tools, that allow the provider to adjust all the different settings to make changes to any of the details of the rewards program, as in act 222.

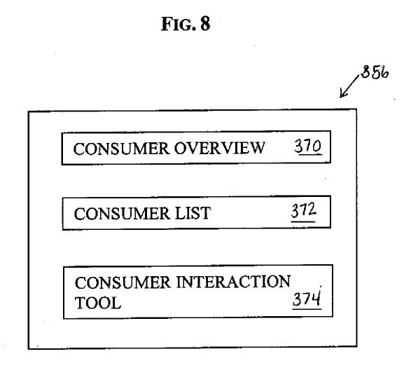

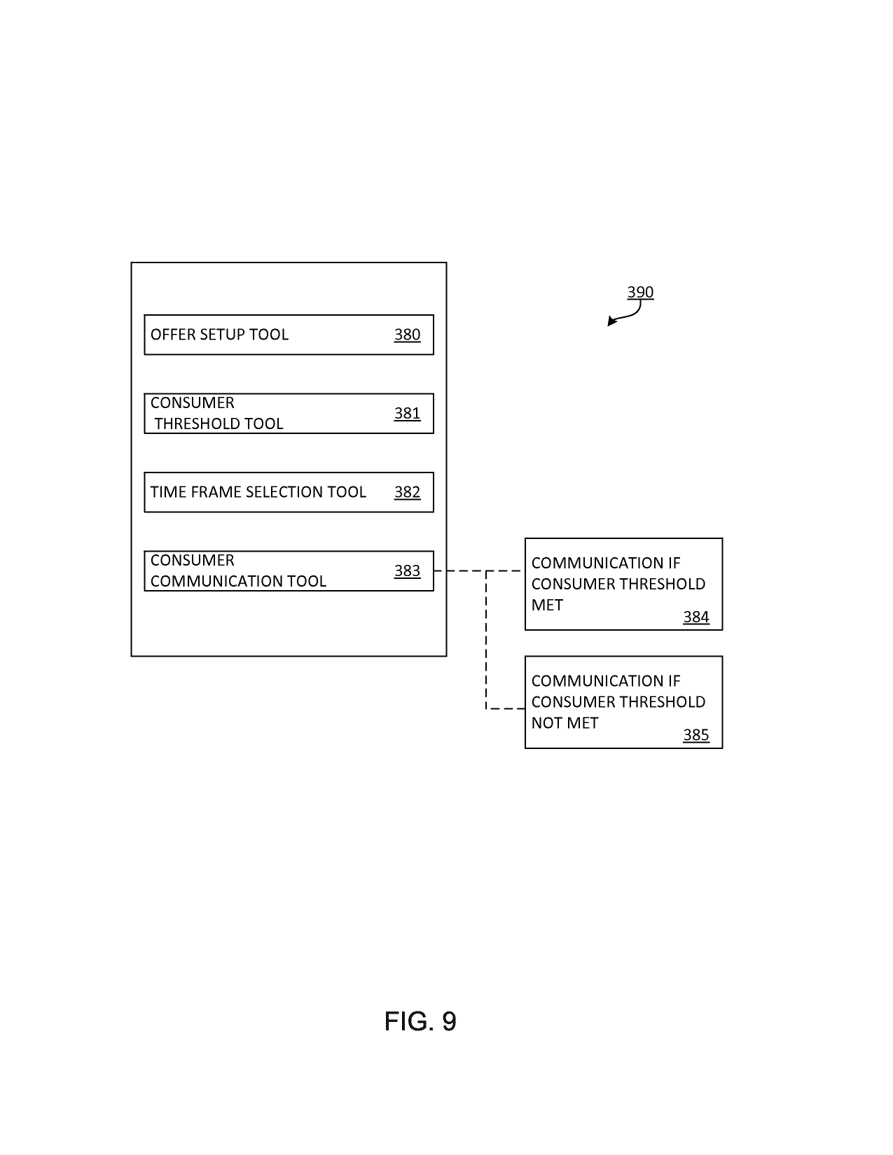

In act 208, the provider is presented with an interface regarding information about consumers that are enrolled in the rewards program, as shown in FIG. 4C in act 230. The provider can view a list of consumers that are enrolled in the rewards program and view the amount of rewards points associated with each consumer. It is also possible that the provider can access information about transaction activity associated with each consumer and information about rewards points redemption associated with each consumer enrolled in the rewards program. Providing this amount of information to the provider about the consumers and the consumer activity allows the provider to track the usage of their rewards program and which types of interactions with consumers have the most positive effect on transaction and rewards program enrollment and usage, such as referral points, advertisements, and group points offering, as will be explained in more detail below. As explained above, the provider is presented with an interface in the form of the main screen 350 that can include a consumer information tool 356 that allows the provider to access information about the consumers that are enrolled in the rewards program and manage those consumers, as in act 232. The consumer information tool 356 allows the provider to view consumer overview information 370 and a consumer list 372, as shown in FIG. 8. The consumer information tool 356 also provides the ability to interact with the consumer using a consumer interaction tool 374, which will be discussed in more detail below.

In act 210, the provider has the ability to interact with the consumer through a variety of channels, including advertisements, announcements, and referrals. In act 240, shown in FIG. 4D, a setup screen is presented to the provider on the provider access device 20, for example, in the form of a graphical user interface element that can provide options for interacting therewith in the form of text, icons, pictures, or other graphical indicators communicating various options to the provider. The setup screen can allow the provider to setup a communication with one or more consumers, including consumers both enrolled in the rewards program and consumers that are not currently enrolled in the rewards program. The provider can access the functionality for these features through the consumer interaction tool 374 in the consumer information tool 356, or a separate tool can be available to the provider for consumer communication. For example, a consumer communication tool (not shown) can be presented to the user on the main screen 350. In act 242, the provider is presented with an interface to create an announcement or advertisement for communication with one or more consumers. For example, a communication creation tool can be presented to the provider that allows the provider to create a communication for consumer. In act 244, the provider can select the recipients of the communication. For example, the provider can select all of the consumers enrolled in the rewards program, or a subset of those consumer based on the content of the communication. In act 246, the provider can select the timing of the delivery of the communication. In act 248, the provider has the ability to manage any current announcements of advertisements that have been created to allow the provider to alter the content of the communication, the set of consumers to receive the communication, and/or the timing of the delivery of the communication to the consumers.

The provider also has the ability to setup parameters for consumers referring other consumers to the provider and the rewards program of the provider, in act 250. This can include the offering of rewards points or fractions of rewards points to consumer for these referrals, in act 252.

In act 212, the provider has the ability to present group offering to one or more consumers. A group offering allows a provider to offer a group of consumers an increased number of points or other incentive for a certain activity if a pre-determined number of consumers agree to the terms of the group offering. In act 260, shown in FIG. 4E, a provider can set up the parameters for a group offering. A graphical user interface element may be displayed to the provider on the provider access device that is configured to display the group offering interface 390 to the provider to allow the provider to access various features regarding a group offering. In one embodiment, the group offering interface 390 can include an offer setup tool 380 that can allow the provider to enter or selection various options for a group offering. For example, the provider can specify what types of activity or transactions the consumer must engage in to receive the group offering, such as the purchase of a certain product. In act 262, the provider can select the consumers that will be offered the group offering. A consumer threshold tool 381 can be provided as part of the group offering interface 390 and can be configured to allow the provider to select the consumers to receive the group offering and the number of those consumer required for the group offering to become valid. The consumer threshold tool can provide a list of all the consumer enrolled in the rewards program and allow the provider to select those to receive the group offering, and/or the consumer threshold tool 381 can allow the provider to select all of the consumers or subsets of consumers based on various parameters, such as location or past transactions. In act 264, the provider can select the time frame during which a consumer must accept the group offering. A time frame selection tool 382 can be provided as part of the group offering interface 390 and can be configured to allow the provider to select the time frame of the group offering. The time frame selection tool 382 can allow the provider to enter a time frame or allow the provider to select from a list of time frames provided by the time frame selection tool 382. After all the settings are entered by the provider, the group offering is communicated to the consumers by a variety of means, including email, text message, evite, or any other communication means. After the time frame for response to the group offering has elapsed, a message is relayed to the consumers to notify them of whether or not the group offering is valid based on whether or not the threshold number of consumer had accepted the group offering. The messaging tool 383 of the group offering interface 390 allows the provider to create a message to be sent to the consumers. It will either be a message informing the consumers that the group offering is valid as in message 384, or a message that the group offering is not valid as in message 385.

In act 214, the provider has the ability to join and/or participate in a provider consortium that allows the providers to combine rewards program and/or share rewards points to allow a consumer to redeem rewards points with multiple providers. For example, this would allow rewards points that are accrued with a first provider to be redeemed with that first provider or with a second provider if the first and second providers have agreed to participate in a provider consortium. The provider partnership can allow the providers in partner in a variety of ways, including providing joint rewards points offers to consumers, or sharing accrued rewards points to allow the consumers to use the rewards points from each provider interchangeably among the providers in the partnership. In addition, a provider partnership can include any number of providers sharing rewards programs and/or rewards points in any way that is agreed to by the participating providers.

In act 270, shown in FIG. 4F, a provider consortium screen is presented to the provider on the provider access device 20. A graphical user interface element may be displayed to the provider on the provider access device 20 that is configured to display a provider consortium screen to the provider to allow the provider to access various features of the provider consortium. In one embodiment, the provider consortium screen interface can include a search tool that can allow the provider to search the provider consortium for potential provider partnerships, as in act 272. The provider can search for potential provider partnerships based on a variety of criteria, including but not limited to provider location and/or provider type, such as the type of goods or services offered by the provider. The search tool can display the results of the search to the provider, and the provider can select to enter into a provider partnership with one of the providers shown in search results, as in act 274. In act 276, a communication can be sent to the provider chosen for the potential provider partnership to communicate that the provider has been selected by another provider, and asking for confirmation for entering into the partnership.

The provider consortium screen interface can also include a setup tool that can allow the provider to enter parameters for a potential provider partnership, as in act 278. In act 280, the parameters entered by the provider are communicated to the provider consortium to be searched for and viewed by other providers. The provider consortium parameters can include a variety of information. For example, legal terms can be provided that explain that each provider in the particular provider consortium agrees to accept rewards points from the other providers in that provider consortium. The terms can also include a timeframe during which the provider consortium will exist such that the providers are only obligated to accept the rewards points from the other providers during that timeframe. This allows a provider to enumerate an end date for that particular provider consortium agreement in the parameters.

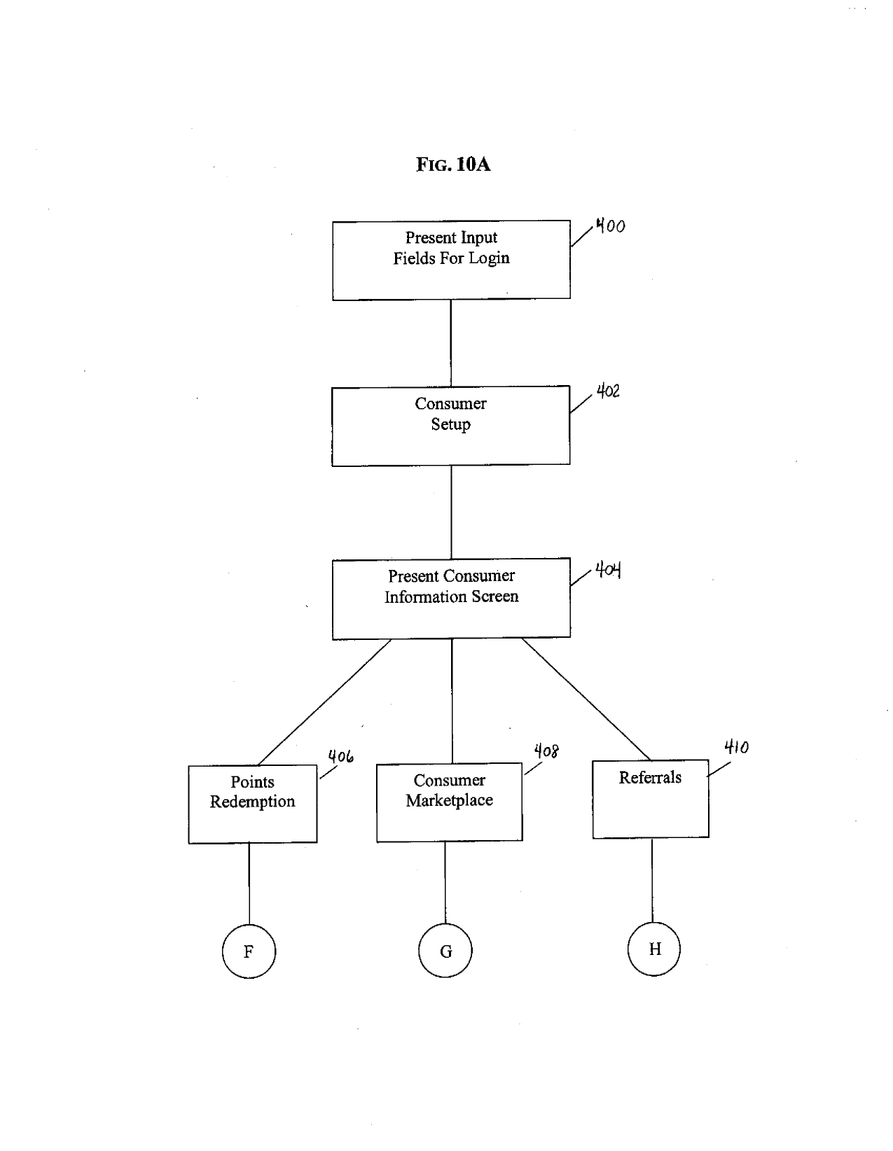

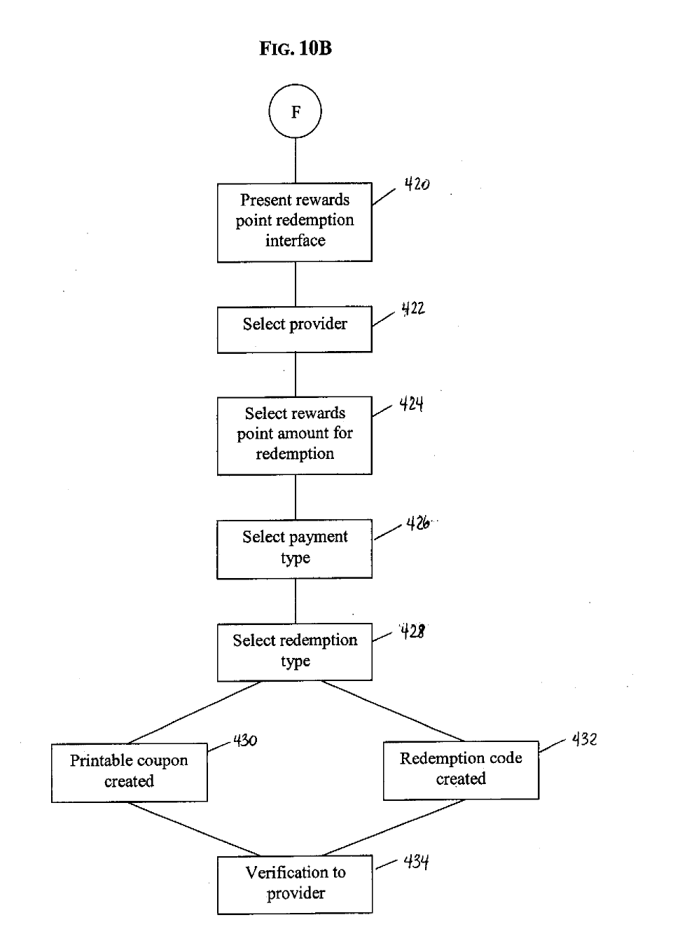

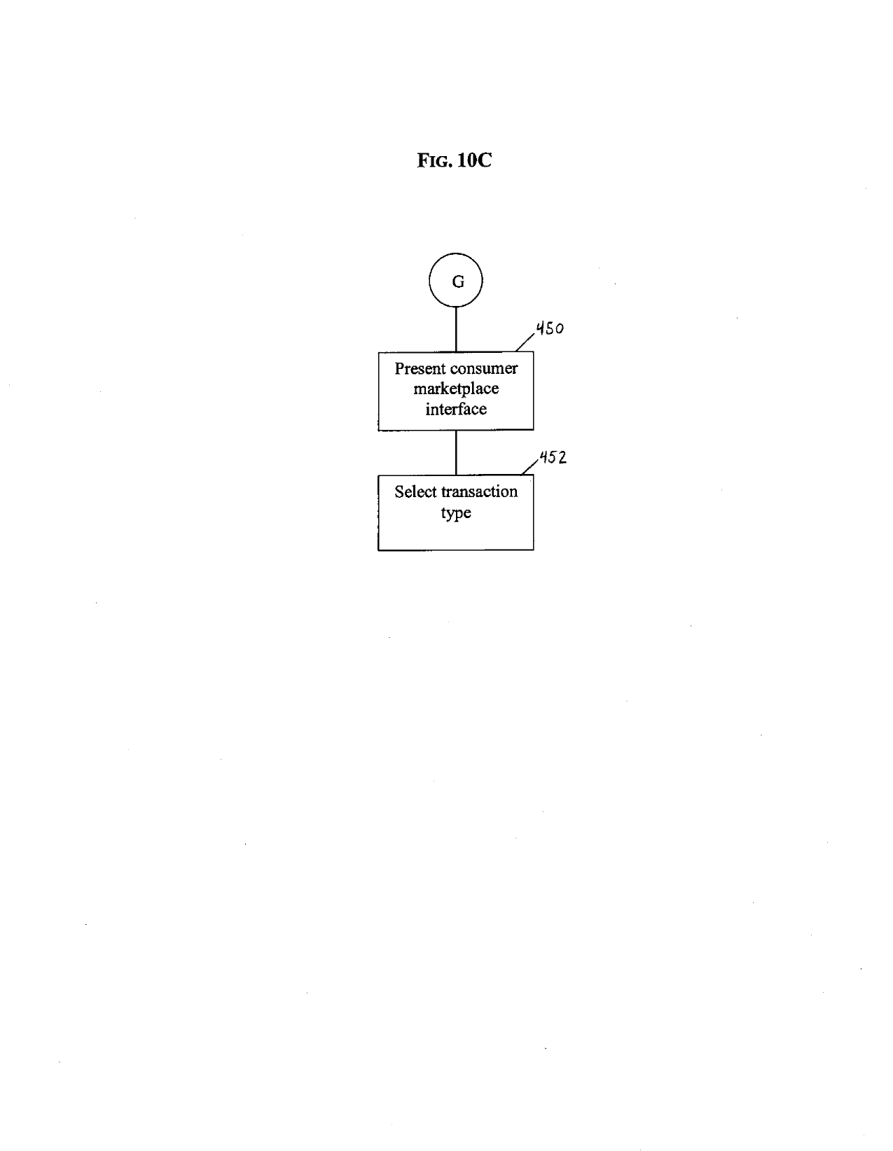

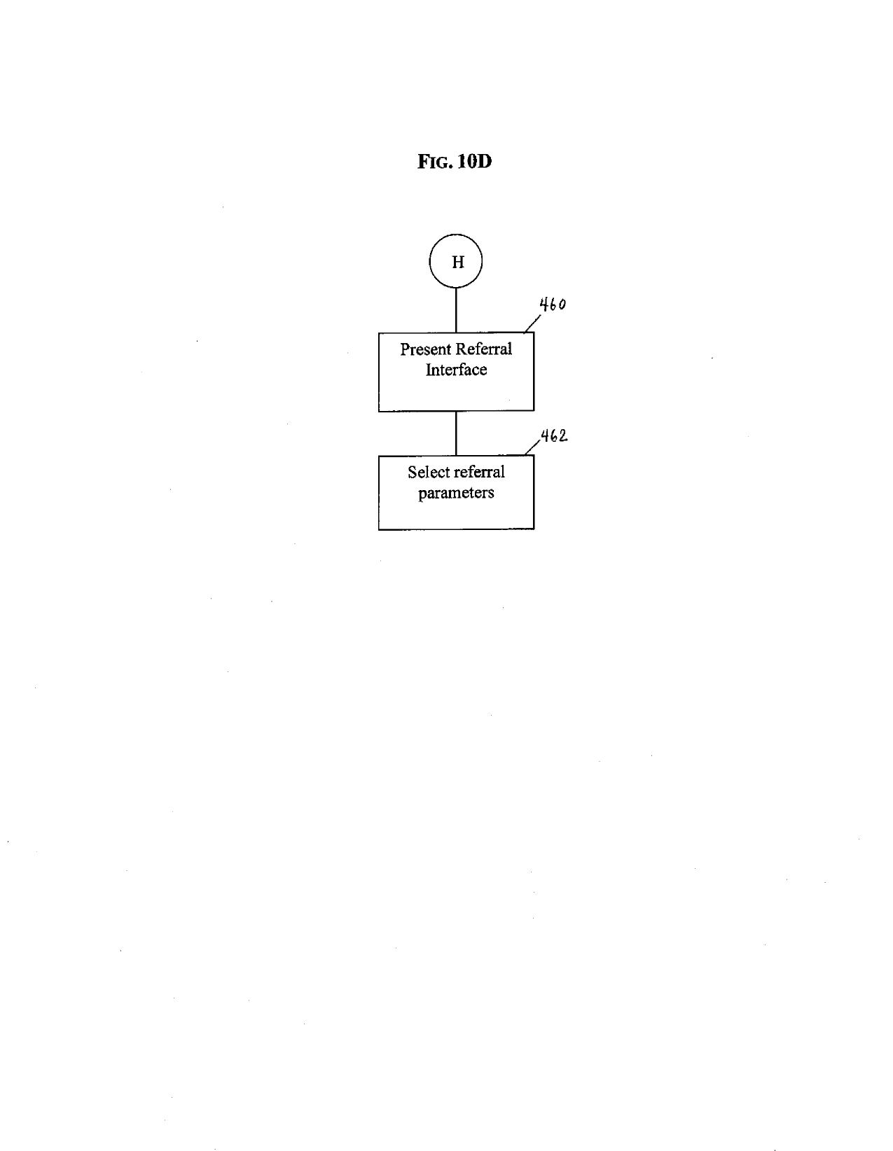

FIGS. 10A-10D show a flowchart of processes that allow a consumer to create an account with the communications system 10 and/or manage and redeem rewards points from one or more rewards programs. The illustrated processes are carried out, in the illustrated embodiment, by the communications system 10 shown in FIG. 1. In act 400, a main/login page is presented on the consumer access device 24, for example, on a display on the consumer access device 24, to allow the consumer to enter the communications system 10. In one embodiment, the login screen may include, for example, authentication graphical tools, such as username and password graphical tools. In another embodiment, the login screen may employ non-graphical authentication tools to allow the consumer to log into the system.

When graphical tools are provided, the authentication graphical tools may be graphical input/output tools that communication to the consumer the type of information to be input, and then accept that input from the consumer. The username graphical tool and the password graphical tool may include an input field for text to allow the consumer to enter a username and password into the login screen. For example, a consumer may be provided with a unique login account including a unique username.

Additional graphical tools may be provided in addition to the username graphical tool and the password graphical tool. Similar to the graphical tools that may be provided to the provider, the additional graphical tools may be part of the same login page as the username graphical tool and the password graphical tool, or may be presented on a separate page or through the use of an access wizard. As explained above with respect to the providers, additional graphical tools can include a graphical tool for when a consumer has forgotten the password for login.

Additional graphical tools may be provided in an instance where the consumer is required to set up an account with the communications system 10, at act 402. The consumer setup in act 402 is only required one time when a consumer accesses the system for the first time, and can be skipped upon all subsequent visits. During the consumer setup in act 402, a consumer provides information about the consumer to the communications system 10. This information can include a listing of any rewards programs that the consumer is currently enrolled in. Various tools can be employed to receive information from the consumer to set up an account with the system. For example, a graphical tool can be employed when a consumer has to set up a new account. This tool can present the consumer with various other tools for entering information about the consumer. For example, a consumer can provide information including consumer name, contact information including mailing address, telephone number, and/or contact email address, a password, password confirmation, password secret question and answer in the event of a forgotten password, and/or other pertinent information.

In one embodiment, various materials and other information can be communicated to the consumer upon the creation of an account with the communications system 10. In one embodiment, a consumer can be provided with a rewards point card that can allow the consumer to accumulate rewards points using the card when entering into transactions with participating providers with the communications system 10. In one embodiment, the card can include a magnetic strip that can be swiped when a consumer transacts with a provider to collect the rewards points accumulated during that transaction.

In another embodiment, various types of two-dimensional barcodes, such as QR codes or Microsoft tags, can be used to allow consumer to accrue and redeem rewards points. In yet another embodiment, a telephone number and/or email address associated with a consumer could be used to allow a consumer to accrue and redeem rewards points.

In act 404, the consumer is presented with a consumer information interface that presents to the consumer a variety of information regarding the enrollment of the consumer in one or more rewards programs. A graphical user interface element may be displayed to the consumer on the consumer access device 24 that is configured to display the consumer information interface to the consumer to allow the consumer to view and/or interact with various aspects of various rewards programs in which the consumer is enrolled.

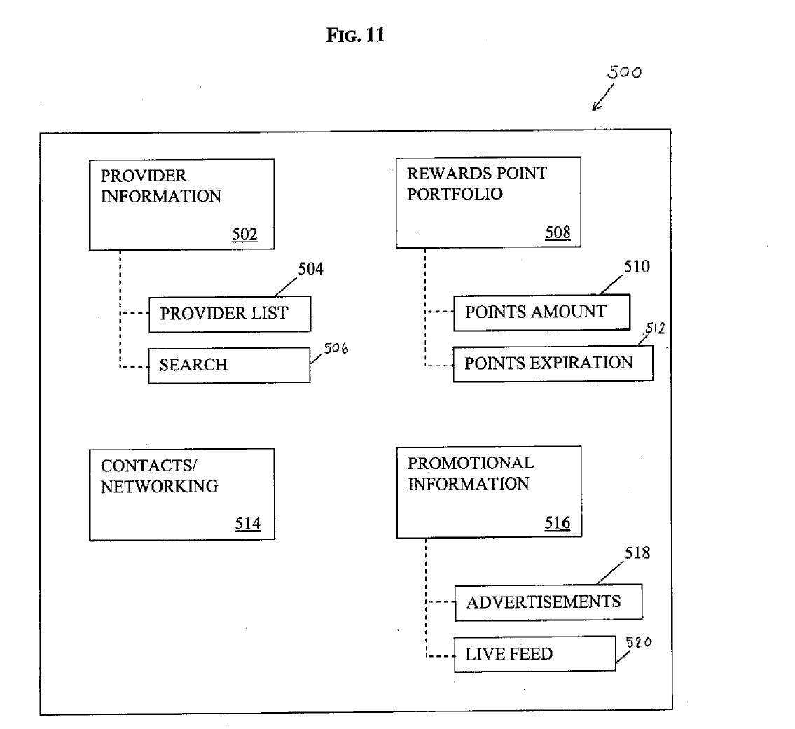

In one embodiment shown in FIG. 11, a consumer information interface 500 is presented to the consumer to allow the consumer to view and/or interact with various aspects of the communications system 10. A provider information tool 502 is provided that presents to the consumer the one or more rewards programs in which the consumer is enrolled. For example, the provider information tool 502 can present the consumer with a list 504 of provider names with rewards programs in which the consumer is enrolled. The provider information tool 502 can also include a search tool 506 that allows the consumer to search for rewards programs for enrollment. The search tool 506 can provide search functionality to the consumer in a variety of ways, including allowing the consumer to search by provider type and/or location, by product or service type, select keywords, or any other method of searching.

The consumer information interface 500 also includes a rewards point portfolio tool 508 that present information to the consumer about the rewards points that the consumer has accrued. The rewards point portfolio tool 508 presents the amount of points 510 that a consumer has for each rewards program the consumer is enrolled in, and can also present the expiration date 512 of those rewards points if applicable. The consumer information interface 500 also includes a contacts/networking tool 514 for allowing the consumer to communicate through the communications system 10 with other consumers.

A promotional information tool 516 can allow the consumer to view various types of communications from the providers, including advertisements 518 and a live feed 520 of updates from the providers. In one embodiment, the live feed 520 allows the consumers to choose to view various types of information from all of the providers in the communications system 10, whether or not the consumer is enrolled in a provider's rewards program. When a consumer chooses to view the live feed 520, they can view various types of information, including information about new providers in the communication system 10, or promotions or deals offers by providers. The live feed 520 can include information from providers based on a variety of criteria, including location of the consumer to allow the information in the live feed 520 to be more directly targeted to the consumer. It will be appreciated, however, that the live feed 520 can include all information provided by the providers to the live feed 520, or can be restricted based on a various types of criteria, including locations of the providers or types of product and/or services offered by the providers.

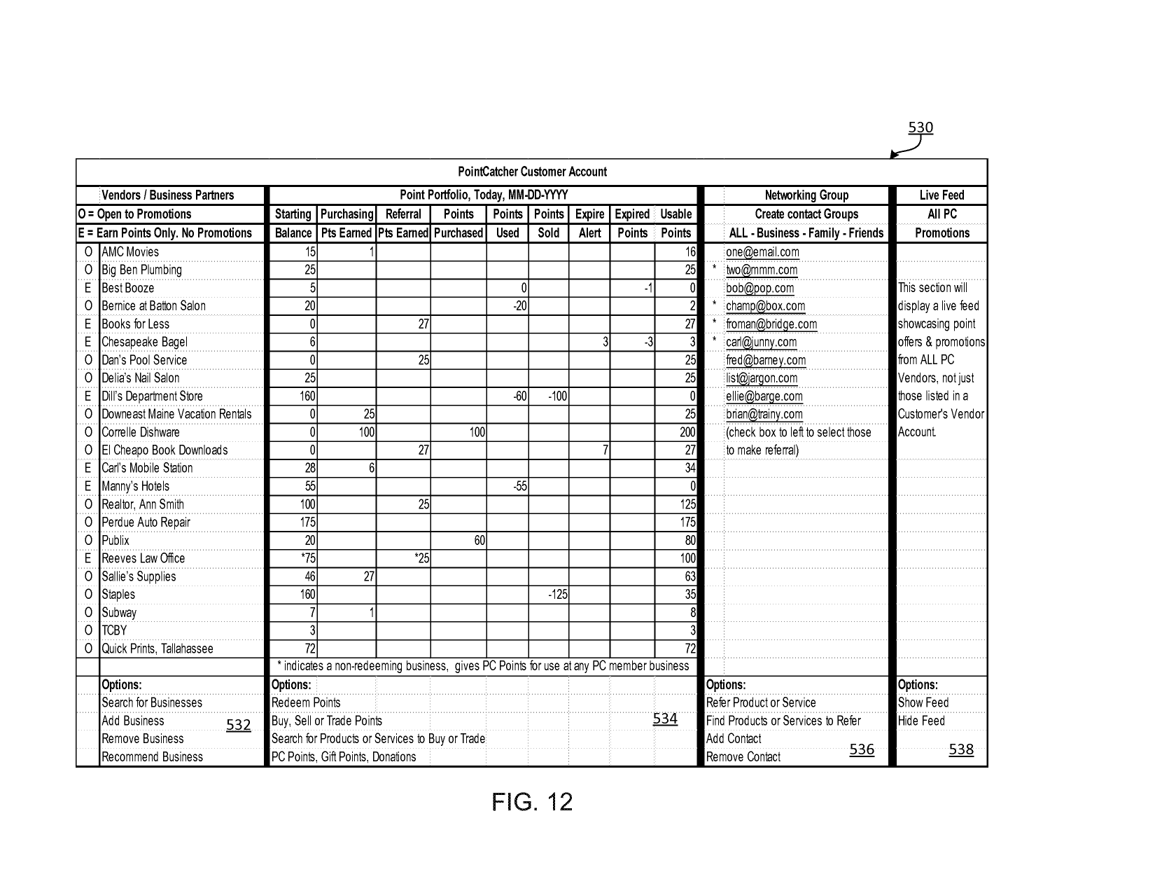

Another embodiment of a consumer information interface is shown in FIG. 12. A consumer information interface 530 is presented to the consumer to allow the consumer to view and/or interact with various aspects of the communications system 10. A provider information tool 532 allows the consumers to view a list of providers that have rewards programs in which the consumer is enrolled. This list can provide additional information about each provider, including those that have promotions. The provider information tool 532 can also include additional graphical tools that allow the consumer to search for additional providers, add or remove providers from the provider list, or recommend one or more providers to other consumers. The provider information tool 532 can also allow the consumer to select which providers can communicate various promotions or additional contacts to the consumer. This allows the consumer to control the amount of contact the providers can have with that consumer.

A points portfolio tool 534 allows the consumer to view information about rewards points associated with each provider in the provider list of the provider information tool 532. In one embodiment, the consumer can view information about a starting balance of rewards points, purchasing points earned with the provider, referral points earned with the provider, rewards points that have been purchased by the consumer from the provider, rewards points used, rewards points sold, an expiration date or expiration alert on the rewards points, number of expired rewards points, and total amount of usable rewards points for each provider. The consumer can also have access to tools to allow them to customize the points portfolio to allow the consumer to view any subset of available information about their rewards points. For example, a consumer can choose to see only the total number of usable rewards points and hide the rest of the rewards points information. The points portfolio tool 534 can also include additional tools to allow the consumer to redeem rewards points, engage in rewards points commerce, or view information about universal rewards points.

A networking tool 536 allows a consumer to view a list of contacts that can include providers and/or other consumers. The networking tool 536 can also include additional tools to allow the consumer to add and remove contacts, and search for and refer products, services, or providers to any of the contacts in the contact list. A live feed tool 538 can also be provided that allows the consumers to view any promotions, advertisements, or other communications from providers, including providers that have rewards programs that the consumer is enrolled in and/or all the providers associated with the communications system 10. The live feed tool 538 can also include the option for the consumer to show or hide the live feed.

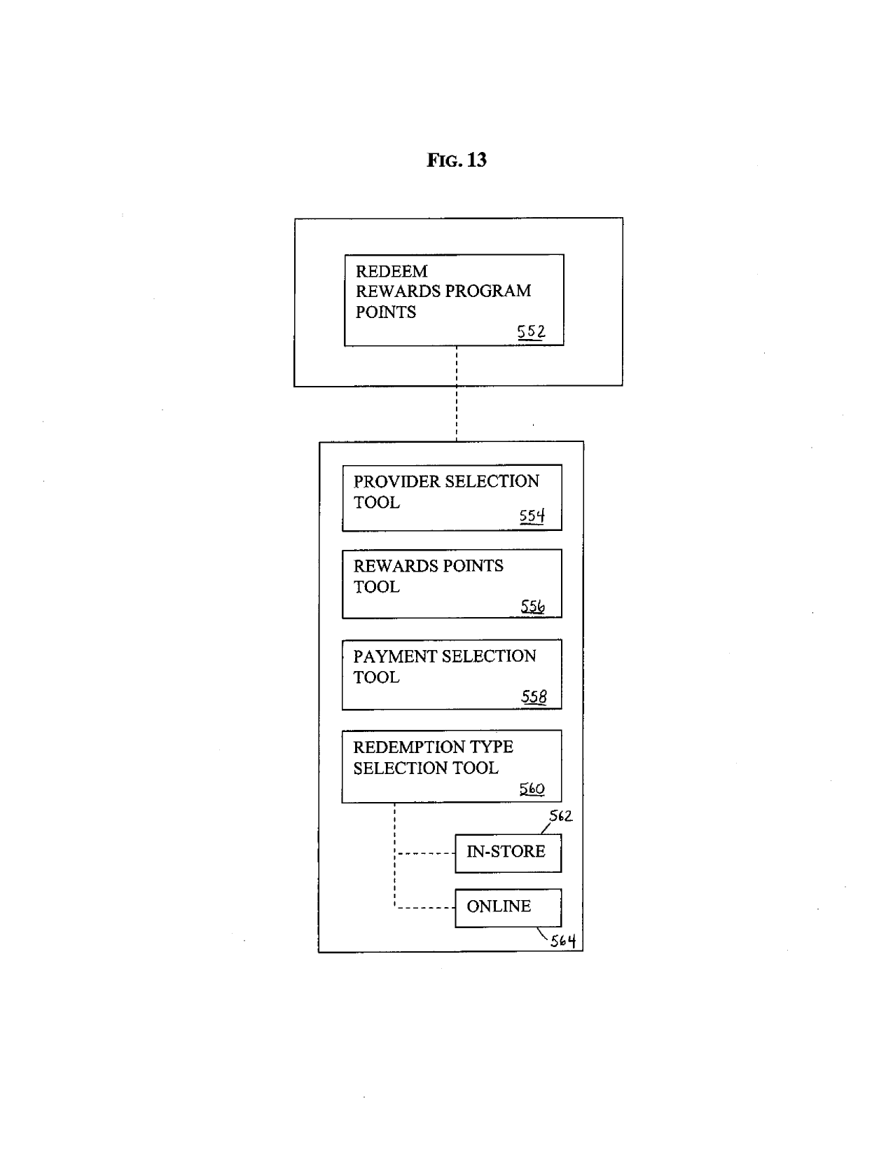

In act 406, a consumer is presented with an interface to allow the consumer to redeem rewards points for use with the provider. As shown in FIG. 13, a rewards point redemption interface 500 is presented to the consumer to allow the consumer to select rewards points for redemption, as in act 420. The rewards point redemption interface 500 can be in the form of a graphical user interface element that may be displayed to the consumer on the consumer access device 24 to allow the consumer to redeem rewards points. The options presented to the consumer may be depicted with text, icons, pictures, or other graphical indicators communicating various choices to the consumer. The consumer selects the rewards points to be redeemed using a rewards program points tool 552. In act 422, the consumer selects the provider whose rewards points the consumer wants to redeem and can use the provider selection tool 554 of the rewards program points tool 552. The provider selection tool 554 can present a list of providers with whom the consumer has accrued rewards points and allow the consumer to select a provider from the list, or the provider selection tool 554 can allow the user to input a provider whose rewards points the consumer wants to redeem. In act 424, the consumer selects the number of rewards points for redemption. A rewards points tool 556 can be presented to the consumer that allows the consumer to input or select an amount of rewards points to be redeemed, with the maximum rewards points being the maximum number of rewards points that the consumer has accrued with the chosen provider, or the maximum number of rewards points may be a threshold set by the provider during setup of the rewards program. For example, the template with which the provider sets up the rewards program can allow the provider to set a maximum number of rewards points that may be redeemed in a single transaction, or in a certain time period.

If the communications system 10 requires that the consumer pay for each rewards point redemption, the consumer can select a payment type in act 426. A payment selection tool 558 can be presented to the consumer to allow the consumer to input or select from various payment options, including a credit card, bank account withdrawal, debit card withdrawal, universal rewards points, or any other payment type. It will be appreciated that the system may or may not require payment from consumers for the use of their rewards points. It will also be appreciated that the consumer could be required to pay for certain actions with the communication system 10. For example, the consumer can be required to pay for the commerce of rewards points, including the buying, selling, and/or trading of rewards points, as will be described in more detail below.

In act 428, the consumer can select the type of rewards point redemption, including a printable coupon for use in a retail location as in act 430, a redemption code for online transactions, or a two-dimensional bar code for use in a retail location, such as a QR code or a Microsoft tag, that can uploaded onto a communications device such as a smartphone, as in act 432. A redemption type selection tool 560 can be presented to the consumer to allow the consumer to select the type of rewards point redemption. The redemption type selection tool 560 can include an in-store tool 562 that would provide the consumer with a coupon, such as a printable coupon or a QR code or Microsoft tag, to be used in a retail location. An online tool 564 would provide the consumer with a code, such as an online redemption code, to allow the consumer to use the selected rewards points at an online location. In act 434, verification is communicated to the provider to inform the provider that a consumer has redeemed rewards points. The communication can include a variety of information, such as the name of the consumer, the date of rewards points redemption, the number of rewards points redeemed, and the selected redemption type.

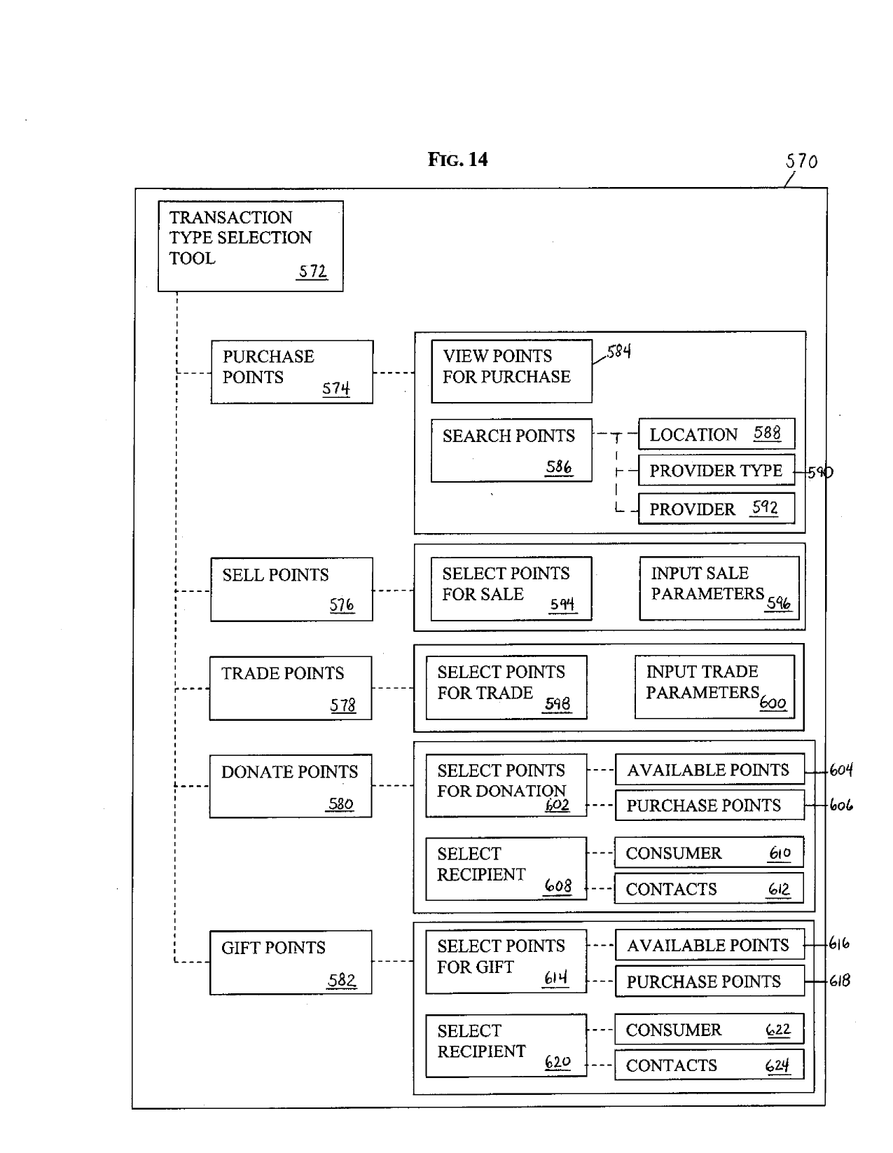

In act 408, a consumer can enter a consumer marketplace to engage in rewards points transactions with other consumers in the communications system 10. A consumer can transact with other consumers in a variety of ways, but in one embodiment, the consumer can buy, sell, trade, donate, or gift rewards points to another consumer or other entity. In act 450, the consumer is presented with a consumer marketplace interface 570 as shown in FIG. 14, to allow the consumer to engage in the transaction of rewards points with other consumers. The consumer marketplace interface 570 can be in the form of a graphical user interface element that may be displayed to the consumer on the consumer access device 24 to allow the consumer to engage in the transaction of rewards points. The options presented to the consumer may be depicted with text, icons, pictures, or other graphical indicators communicating various choices to the consumer. In act 452, the consumer selects the transaction type using a transaction type selection tool 572. In this regard, the type of transaction may be selected by interacting with one of a purchase points tool 574, a sell points tool 576, a trade points tool 578, a donate points tool 580, or a gift points tool 582, each of which includes a mechanism for accessing further tools for reviewing and selecting parameters associated with each transaction type.

A consumer may purchase rewards points using the purchase points tool 574 of the transaction type selection tool 572. A consumer can purchase points from another consumer that has accrued the desired rewards points, or the consumer can purchase rewards points from the provider. The consumer can either view a list of rewards points that are available for purchase by selecting the view points for purchase tool 584, or the consumer can search for rewards points for purchase by selecting the search points tool 586. Using the search points tool 586, the consumer can search for rewards points for purchase in a variety of ways, including by location 588, provider type 590, and/or provider name 592.

A consumer may sell rewards points using the sell points tool 576 of the transaction type selection tool 572. A consumer can sells points to another consumer from available rewards points that the consumer has accrued as long as the provider has not included a limitation on the sale of rewards points into the provider's rewards program. Using the select points for sale tool 594, the consumer can select rewards points from a list of rewards points available to the consumer for sale to another consumer. The input sale parameters tool 596 allows the consumer to enter any parameters associated with the sale of the rewards points, including a time frame in which the consumer desires to sell the rewards points.

A consumer may trade rewards points using the trade points tool 578 of the transaction type selection tool 572. A consumer can trade points to another consumer from available rewards points that the consumer has accrued as long as the provider has not included a limitation on the trade of rewards points into the provider's rewards program. Using the select points for trade tool 598, the consumer can select rewards points from a list of rewards points available to the consumer for trading to another consumer. The input trade parameters tool 600 allows the consumer to enter any parameters associated with the trade of the rewards points, including a time frame in which the consumer desires to trade the rewards points and the type of rewards points the consumer is seeking, including a location of the provider, a provider type, or a provider name.

A consumer may donate rewards points using the donate points tool 580 of the transaction type selection tool 572. A consumer can donate points to another consumer or any entity from available rewards points that the consumer has accrued as long as the provider has not included a limitation on the donation of rewards points into the provider's rewards program. Using the select points for donation tool 602, the consumer can select rewards points from a list of rewards points available to the consumer for donation using the select available points tool 604, or the consumer can purchase rewards points for donation using the purchase point for donation tool 606, which can direct the consumer to the purchase points tool 574. The select recipient tool 608 allows the consumer to select the entity to which the donation of rewards points will be made. The consumer tool 610 allows the consumer to select another consumer from the communications system 10 to receive the donation. The contacts tool 612 allows the consumer to select the donation recipient from a contact list that many include consumers or entities that are not currently associated with the communication system 10.

A consumer may gift rewards points using the gift points tool 582 of the transaction type selection tool 572. A consumer can gift points to another consumer or any entity from available rewards points that the consumer has accrued as long as the provider has not included a limitation on the gifting of rewards points into the provider's rewards program. Using the select points for gift tool 614, the consumer can select rewards points from a list of rewards points available to the consumer for gifting using the select available points tool 616, or the consumer can purchase rewards points for gifting using the purchase point for gifting tool 618, which can direct the consumer to the purchase points tool 574. The select recipient tool 620 allows the consumer to select the entity to which the gift of rewards points will be made. The consumer tool 622 allows the consumer to select another consumer from the communications system 10 to receive the gift of rewards points. The contacts tool 624 allows the consumer to select the gift recipient from a contact list that many include consumers or entities that are not currently associated with the communication system 10.

In act 410, a consumer is presented with an interface to refer providers to other consumers. A consumer can be presented with a referral interface to allow the consumer to engage in the referral of rewards programs or providers with other consumers. The referral interface can be in the form of a graphical user interface element that may be displayed to the consumer on the consumer access device 24 to allow the consumer to refer providers or rewards programs, as in act 460. In act 462, the consumer can select parameters for referring a provider or rewards program to another consumer, including the selection of one or more consumers enrolled in the communications system 10 or one or more consumers not currently enrolled in the communications system 10.

The claims as originally presented, and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. Apparatus, comprising:
a provider interface configured to communicate with at least one provider access device;
a consumer interface configured to communicate with at least one consumer access device;
a rewards program engine configured to communicate with the provider interface to allow a provider to create and manage a rewards program for offering rewards points to one or more consumers as part of a transaction, the rewards program engine being configured to present a template to the provider for creating the rewards program, the rewards points being available for use in subsequent transactions with the provider; and
a consumer rewards engine configured to communicate with the consumer interface to allow a consumer to manage rewards points from one or more providers.

2. The apparatus of claim 1, wherein the at least one consumer access device includes memory, interface circuitry, and at least one user interface component configured to communicate with at least one input device.

3. The apparatus of claim 1, wherein the at least one consumer access device includes an embedded device.

4. The apparatus of claim 3, wherein the at least one consumer access device includes a smartphone.

5. The apparatus of claim 1, wherein the at least one provider access device includes memory, interface circuitry, and at least one user interface component configured to communicate with at least one input device.

6. The apparatus of claim 1, wherein the at least one provider access device includes an embedded device.

7. The apparatus of claim 6, wherein the at least one provider access device includes a smartphone.

8. The apparatus of claim 1, further comprising a marketplace engine configured to communicate with the consumer interface to allow a consumer to engage in the transaction of rewards points.

9. The apparatus of claim 1, further comprising a service provider device configured to communicate with the provider interface and the consumer interface, the service provider device being configured to manage the communication therebetween.

10. A method, comprising:
providing an interface for communication with at least one provider access device;
presenting a template to a provider using the provider access device for creating a rewards program to allow a provider to create and manage a rewards program for offering rewards points to one or more consumers as part of a transaction, the rewards points being available for use in subsequent transactions with the provider.

11. The method of claim 10, further comprising creating the rewards program using information selected by the provider using the template presented thereto, and presenting one or more user interfaces to the provider for managing the rewards program and the rewards points accrued by the one or more consumers as part of a transaction with the provider.

12. Computer-readable media encoded with data, the encoded data interoperable with a machine to cause:
providing an interface for communication with at least one provider device;
presenting a template to a provider using the provider device for creating a rewards program to allow a provider to create and manage a rewards program for offering rewards points to consumers as part of a transaction, the rewards points being available for use in subsequent transactions with the provider.

13. The method of claim 12, further comprising creating the rewards program using information selected by the provider using the template presented thereto, and presenting one or more user interfaces to the provider for managing the rewards program and the rewards points accrued by the one or more consumers as part of a transaction with the provider.
